(19) United States
(12) Patent Application Publication
(10) Pub. No.: US 2015/0234391 A1
(43) Pub. Date: Aug. 20, 2015

(54) SUBMERGED ROTOR FLOW CONTROL VALVE

(71) Applicant: Paul Francis Sabadin, Carlsbad, CA (US)

(72) Inventor: Paul Francis Sabadin, Carlsbad, CA (US)

(21) Appl. No.: 14/628,167

(22) Filed: Feb. 20, 2015

Related U.S. Application Data
(60) Provisional application No. 61/972,361, filed on Mar. 30, 2014.
(60) Provisional application No. 61/942,530, filed on Feb. 20, 2014.

(51) Int. Cl. G05D 7/01

(52) U.S. Cl. CPC G05D 7/018

(57) ABSTRACT

A valve for controlling fluid flow may include a conduit with an inlet and an outlet. A modulating orifice of the valve can include a flow passage, the size of which can be varied by movement of a flow control element that moves in response to rotation of a magnetic rotor acted upon by a stator of a motor. The magnetic rotor can be submerged within a fluid passing through the conduit of the valve. Apparatus, systems and methods of use and making of valves having one or more of these features are described.

### CROSS-REFERENCE TO RELATED APPLICATION

This application claims priority under 35. U.S.C. §119(e) to U.S. Provisional Application Ser. No. 61/972,361, filed Mar. 30, 2014, entitled “Low Friction Valve” and to U.S. Provisional Application Ser. No. 61/942,530, filed Feb. 20, 2014, entitled “Energy Harvesting Computerized Wireless Valve.” This application is also related to Patent Cooperation Treaty Application No. PCT/US2014/015641, entitled “Process and System for Controlling Modulation Assisted Valves for the Internet of Things.” Each application referenced in this paragraph is incorporated by reference in its entirety.

### TECHNICAL FIELD

The subject matter described herein relates to fluid control valves, for example for use in applications where fluid may be supplied according to a measurable or detectable need, for example irrigation or fire suppression.

### BACKGROUND

In irrigation applications, installation and operation of currently available valves can require a direct connection to a power source and controller. Low energy, easily controllable valves can be a desirable improvement to irrigation systems and other systems or flow networks in which fluid flow control is necessary.

### SUMMARY

Some aspects of the current subject matter relate to valves that include submerged rotor motors and that can be actuated regardless of a fluid pressure existing across the inlet and outlet of a conduit or body of the valve.

In one aspect, a valve includes a conduit that has an inlet and an outlet. The conduit is configured to receive a fluid via the inlet and to discharge the fluid from the outlet after the fluid passes through the conduit. The valve further includes a motor that has a stator and a magnetic rotor. The magnetic rotor is disposed to contact the fluid as the fluid passes through the conduit and is positioned with a rotor axis of rotation substantially aligned with a direction of fluid flow through the conduit. The stator is disposed to at least partially encircle the magnetic rotor and to cause rotation of the magnetic rotor around the rotor axis of rotation in response to electrical power provided to the motor. A modulating orifice is located between the inlet and outlet. The modulating orifice includes a flow passage through which fluid can flow. A flow control element is connected to the magnetic rotor such that the flow control element moves in response to rotation of the magnetic rotor. Movement of the flow control element causes a size of the flow passage of the modulating orifice to change in a controllable manner.

In an interrelated aspect, a method includes receiving a fluid into an inlet of a conduit of a valve and causing rotation of a magnetic rotor about a rotor axis of rotation in response to electrical power provided to a motor comprising the magnetic rotor and a stator. The magnetic rotor is disposed to contact the fluid as the fluid passes through the conduit and is positioned with a rotor axis of rotation substantially aligned with a direction of fluid flow through the conduit. The stator is disposed to at least partially encircle the magnetic rotor. The method further includes moving a flow control element connected to the magnetic rotor in response to the rotation of the magnetic rotor. Movement of the flow control element causes a size of a flow passage of a modulating orifice to change in a controllable manner. The modulating orifice is disposed between the inlet and an outlet of the conduit.

In some variations one or more of the following features can optionally be included in any feasible combination. Movement of the flow control element can be reciprocal in a direction along the rotor axis of rotation. The flow control element can include a tapering shape with a first cross sectional size that is smaller than a second cross sectional size, and the first cross sectional size of the flow control element can be disposed closer to the modulating orifice than the second cross sectional size of the flow control element.

The flow control element can rotate about an axis that is parallel to the rotor axis of rotation to change the size of the modulating orifice. The flow control element and the modulating orifice can each include one or more orifices, and rotation of the flow control element can cause these one or more elements to move into greater or lesser alignment to change the size of the flow passage.

The motor can allow flow of the fluid through the motor as the fluid passes through the conduit. The stator can have an at least partially toroidal shape, and the at least partially toroidal shape, the magnetic rotor, and a cylindrical shape of the conduit can be aligned concentrically. At least an inner surface of the at least partially toroidal shape of the stator can be disposed in contact with the fluid. The stator and/or the magnetic rotor can be formed of and/or can include a coating of a corrosion-resistant material.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a schematic diagram illustrating an exterior perspective view of an exemplary valve consistent with implementations of the current subject matter;

FIG. 2A and FIG. 2B show schematic diagrams respectively illustrating a perspective cross-section view of the valve of FIG. 1 in open and closed positions;

FIG. 3A and FIG. 3B respectively show schematic diagrams respectively illustrating an exploded perspective cutaway cross-section and an exploded perspective view of a valve consistent with implementations of the current subject matter in both open and closed positions

FIG. 4A and FIG. 4B show schematic diagrams respectively illustrating perspective and cutaway cross-sectional views of a valve consistent with implementations of the current subject matter;

FIG. 5 shows a schematic diagram illustrating a perspective cutaway cross-sectional view of the valve of FIG. 4A and FIG. 4B;

FIG. 6A and FIG. 6B show schematic diagrams respectively illustrating top views of the open and closed states of the modulation orifice mechanism of a valve consistent with implementations of the current subject matter;

FIG. 7 shows a schematic diagram illustrating an exploded view of features of a valve consistent with implementations of the current subject matter;

FIG. 8 shows a schematic diagram illustrating an exploded view of a stepper motor for use with a valve consistent with implementations of the current subject matter;

FIG. 9 shows a process flow chart illustrating features of a method consistent with implementations of the current subject matter;

FIG. 10 shows a perspective view illustrating features of a wet rotor caged modulation assisted valve (MAV) consistent with implementations of the current subject matter;

FIG. 11 shows an exploded top perspective view illustrating features of a wet rotor caged MAV consistent with implementations of the current subject matter;

FIG. 12 shows a exploded bottom perspective view illustrating features of a wet rotor caged MAV consistent with implementations of the current subject matter;

FIG. 13 shows a perspective view illustrating features of a dry rotor caged MAV consistent with implementations of the current subject matter;

FIG. 14A and FIG. 14B respectively show top and bottom exploded perspective views illustrating features of a dry rotor caged MAV consistent with implementations of the current subject matter;

FIG. 15 shows a section perspective view illustrating features of a dry rotor caged MAV consistent with implementations of the current subject matter;

FIG. 16 shows an external perspective view illustrating features of an automated drip irrigation manifold consistent with implementations of the current subject matter;

FIG. 17 shows a cutaway view illustrating features of an electronic drip irrigation valve manifold with independent solenoids consistent with implementations of the current subject matter;

FIG. 18 shows a detail cutaway view illustrating features of a electronic drip irrigation valve manifold showing solenoid obturators consistent with implementations of the current subject matter;

FIG. 19 shows a view illustrating features of a electronic drip irrigation valve manifold showing attachment of microsprinkler mounts;

FIG. 20 shows a rendering illustrating features of a direction-controlled sprinkler based on a modulation assisted valve (MAV) consistent with implementations of the current subject matter;

FIG. 21 shows a schematic diagram illustrating features of a direction-controlled sprinkler MAV consistent with implementations of the current subject matter;

FIG. 22 shows a perspective view illustrating features of a direction-controlled sprinkler MAV consistent with implementations of the current subject matter in the “off” state;

FIG. 23 shows a perspective view illustrating features of a direction-controlled sprinkler MAV consistent with implementations of the current subject matter in the “on” state;

FIG. 24 shows a perspective cross-section view illustrating features of a direction-controlled sprinkler MAV consistent with implementations of the current subject matter in the “off” state;

FIG. 25 shows a perspective cross-section view illustrating features of a direction-controlled sprinkler MAV consistent with implementations of the current subject matter in the “on” state;

FIG. 26 shows an exploded (disassembled) view illustrating features of a direction-controlled sprinkler MAV consistent with implementations of the current subject matter;

FIG. 27 shows a detail exploded (disassembled) view from the bottom illustrating features of a direction-controlled sprinkler MAV consistent with implementations of the current subject matter;

FIG. 28 shows a detail exploded (disassembled) view from the top illustrating features of a direction-controlled sprinkler MAV consistent with implementations of the current subject matter;

FIG. 29 shows a modulation assisted valve (MAV) consistent with implementations of the current subject matter that includes a latching solenoid to control a ball's blockage of a valve outlet orifice;

FIG. 30 shows a modulation assisted valve (MAV) consistent with implementations of the current subject matter that includes a stepper motor;

FIG. 31 shows a popup sprinkler integrated with a modulation assisted valve (MAV) that includes a stepper motor consistent with implementations of the current subject matter; and

FIG. 32 shows modulation assisted valve (MAV) that uses a latching solenoid to control a sliding trap door obturator, an electromagnetic motor with a submerged rotor, and a lead screw for actuation consistent with implementations of the current subject matter.

When practical, similar reference numbers denote similar structures, features, or elements.

### DETAILED DESCRIPTION

Some implementations of the subject matter described herein include use of a submerged or “wet” magnetic rotor (e.g. an electromagnetic rotor) in a valve. Such valves may provide one or more advantages, which may include, but are not limited to, reduction of friction associated with conventional valve packings, operability using relatively low power inputs, and the option for the valve to be actuated either with or without fluid in the valve being under pressure. In other words, such valves may be operated without the assistance of externally modulating pressure or flow into the valve and may be actuated regardless of the magnitude of pressure imposed across the inlet and outlet ports.

Previously filed, related, and co-owned international application no. PCT/US2014/015641 describes various features of modulation assisted valves (MAV). As described therein, actuation of a MAV involves modulation of the flow or pressure imposed across such valves by an external pressure modulating device (such as another, e.g. solenoid valve). While implementations of the current subject matter include use a submerged or “wet” magnetic rotor to, among other things, obviate the friction associated with valve packings, the current subject matter includes valves that are capable of being operated without the assistance of externally modulating pressure or flow into the valve. Such valves can be actuated regardless of the magnitude of pressure imposed across the inlet and outlet ports.

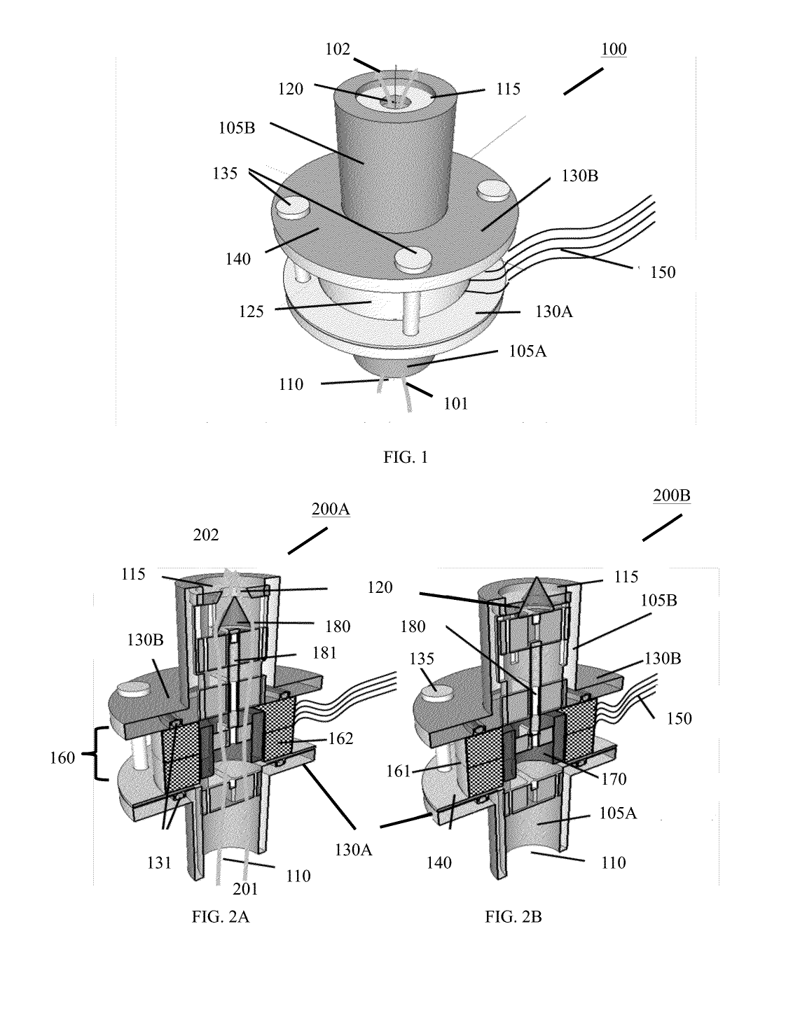

FIG. 1 shows a schematic diagram of an example valve 100 having features consistent with implementations of the current subject matter. The valve 100 may be used as a submerged valve. The valve 100 may allow fluid flow in and out of a conduit in the directions indicated by the arrows 101, 102. The conduit of the valve 100 can be formed as a bottom portion 105A and a top portion 105B. Other configurations of a conduit are also within the scope of the current subject matter. An inlet port or an inlet 110 is located at the bottom portion 105A of the conduit, and an outlet port or outlet 115 is located at the top portion 105B of the conduit in the view of the valve 100 shown in FIG. 1. The inlet and outlet can be configured for joining to other components of a flow control system, such as for example piping, manifolds, other the like. One or more connection approaches, including but not limited to threading, gluing, or the like, can be used with this as well as other valve implementations discussed herein.

Further with reference to FIG. 1, a modulation orifice 120 is located in the valve 100 between the inlet port 110 and the outlet port 115. A motor 125, which can also be referred to as a stepper motor, is also included between the inlet 110 and the outlet 115. The motor 125 may be held in place in the valve 100 with flanges 130A and 103B attached to the conduit. Motor mount screws 135 that pass through stepper motor mount screw holes 140 in the flanges 130A and 130B can hold the motor 125 in place in the valve 100. Wire leads 150 allow a controller to apply current to the motor so that the flow of fluid through the modulation orifice 120 may be controlled without varying the pressure of the fluid through the valve 100. In this regard, and as used herein, control of fluid flow can include either or both of starting/ceasing fluid flow through a valve and adjusting a volumetric rate at which fluid passes through the valve. As shown in FIG. 1, the motor 125 is concentric with the conduit 105A and 105B such that a working fluid (e.g. water or other liquids or gases) can flow in 101 though the inlet port 110, through both the conduit and the motor, and flow out 102 through the modulation orifice 120 and outlet port 115.

FIG. 2A and FIG. 2B respectively show cross-sectional views of the valve in the open configuration 200A and in the closed configuration 200B. In the view of the open configuration 200A, a working fluid flows in 201 through the inlet port 110, flows through the stator 160 and magnetic rotor 170 of the motor 125, around a valve rotor gate assembly 180 and lead screw 181, and out through the modulation orifice 120 that is near the outlet port 115. The size of the modulation orifice 120 may be changed by motion of the valve rotor gate assembly 180. The motor 125 may be energized to incrementally move the valve rotor gate assembly 180 axially through the valve until a desired flow through the valve is reached. The desired flow can optionally be in a range of no flow to a maximum possible flow through the valve (which is generally a function of a fluid pressure differential across the valve). In this and other implementations of the current subject matter, the magnetic rotor 170 can be positioned with a rotor axis of rotation at least approximately aligned with a direction of fluid flow through the conduit, and the stator 160 can at least partially encircle the magnetic rotor 170 such that a toroidal shape (or partial toroidal shape if the stator does not form a complete circle) of the stator 160 is at least approximately concentric with the rotor axis of rotation. For example, for a conduit that is cylindrical in the part of the valve where the magnetic rotor 170 is positioned, the toroidal shape (or partial toroidal shape) of the stator 160, as well as the magnetic stator 170, and the cylindrical shape of the conduit can all be at least approximately concentric.

The view of the closed configuration 200B shows the valve rotor gate assembly 180 in a position that fully obturates, or occludes (e.g. bocks or closes), the modulation orifice 120. In the example shown in FIG. 1 through FIG. 3B, the valve rotor gate assembly 180 moves laterally along the direction of flow in the conduit such that the flow control element at an end of the valve rotor gate assembly 180 closest to the modulation orifice 120 is moved toward or away from the modulation orifice 120. The flow control element in this implementation can have a conical, spherical, or other shape that has at least some taper along its dimension that is parallel to fluid flow in the conduit. In other words, a first part of the flow control element closest to the modulation orifice 120 can have a smaller cross-sectional area than a second part of the flow control element that is farther from the modulation orifice 120. In this manner, movement of the flow control element toward the modulation orifice 120 caused by motion of the valve rotor gate assembly 180 in response to rotation of the magnetic rotor 170 in a first direction causes a flow passage via which fluid can flow through the modulation orifice to be decreased in size (e.g. by reducing a cross-section area available for fluid flow). Conversely, movement of the flow control element away from the modulation orifice 120 caused by motion of the valve rotor gate assembly 180 in response to rotation of the magnetic rotor 170 in an opposite direction to the first direction causes the flow passage via which fluid can flow through the modulation orifice to be increased in size. Said another way, movement of the flow control element is reciprocal in a direction along the rotor axis of rotation.

The valve shown in FIG. 1 through FIG. 3B includes a submerged or “wet” magnetic rotor 170. This type of magnetic rotor 170 may reduce, or even eliminate, the friction associated with valve packings used in other types of valves. The valves described herein may be operated without an additional means for externally modulating pressure or flow into the valve, and the valves may be actuated independent of the magnitude of pressure imposed across the inlet and outlet ports.

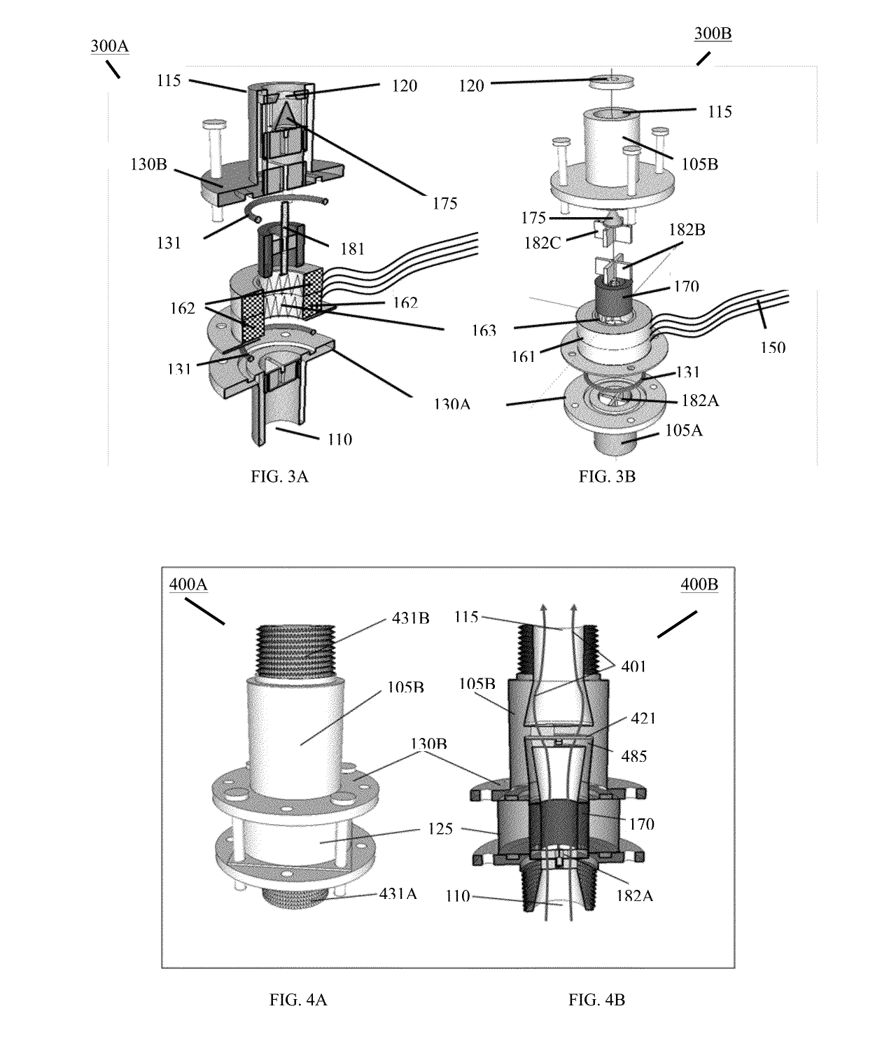

As shown in FIG. 2A, FIG. 2B, FIG. 3A, and FIG. 3B, the motor stator 160 can form a central part of the flow conduit and can be hollow (e.g. toroidal in shape) to reduce flow obstruction presented to fluid flowing through the valve. The magnetic rotor 170 may be made of a corrosion-resistant material, for example a ferrite magnet, and in use is submersed in the working fluid (e.g., water in the case of an irrigation sprinkler) of the valve. The top 105B and bottom 105A portions of the valve conduit attach, with flanges 130A, 130B and O-ring seals 131, to the stator 160. The interior of the stator 160 may be coated with a non-corrosive coating such as plastic or epoxy where it is in contact with the working fluid. Alternatively, the metal parts of the motor may be galvanized to impart corrosion resistance.

FIG. 3 shows exploded views 300A, 300B of the valve. In the first exploded view 300A, the motor stator 160, with the motor stator windings 162 and stator teeth 163 can be seen. The second exploded view 300B shows the magnetic rotor 170 and the valve rotor gate assembly 180, including the obturator member 175 and supporting structures such as the lead screw 181, lower thrust bearing 182A, upper thrust bearing 182B, and the gate sled 182C. The “obturator member” or simply the “obturator” or other comparable terms are used herein to refer to a valve element that occludes or interferes with fluid flow in an adjustable manner. As noted above, such an element can also be referred to as a flow control element. The magnetic rotor 170 may be a permanent magnet stepper magnet that is mounted axially in the flow path 201, 202. It may have a hollow cylindrical shape so that fluid may pass through the center of the magnetic rotor 170, as described above. The magnetic rotor 170 may be fixed with the upper thrust bearing 182B to the lead screw 181. The lead screw 181 and the magnet of the magnetic rotor 170 may be held in vertical position by the spoked upper thrust bearing, or gate sled 182C, and the spoked lower thrust bearing 182A.

The lead screw 181 inserts into the threaded gate sled 182C (lead screw drive nut). In use, when the magnetic rotor 170 turns, the drive screw 181 causes the gate sled 182C to move vertically proportional to the motor revolutions. The gate sled attaches to the valve gating mechanism, or obturator 175. The obturator member 175 moves with the gate sled to preferentially occlude the valve modulation orifice 120, depending on the number of revolutions of the magnetic rotor 170.

A “stop” may be imposed at a particular number of motor revolutions (forward, backward, or both) to stop the stepper motor 125 from moving beyond a predetermined number of revolutions or for setting the magnetic rotor 170 to zero degrees, dead center, thus “resetting” the stepper motor. The modulation orifice and obturator can be made of various materials (e.g. PTFE) that exhibit various sealing, frictional, and mechanical advantages.

FIG. 4A shows an external perspective view 400A of an example of another valve configuration consistent with implementations of the current subject matter. This valve includes an obturator or flow control element that rotates about the rotor axis of rotation (e.g. in a plane normal to the direction of flow of a working fluid) to change the size of the modulation orifice 120. The valve of FIG. 4A includes a multi-component valve conduit 105 with threaded portions 431A and 431B, at the bottom and top ends, respectively. Other connection features besides threading can be used on such valves. The valve conduit 105 also includes an inlet port 110 and an outlet port 115 separated by a modulating device in the middle of the conduit. In use, a motor 160 may move the modulating device.

FIG. 4B shows a cross-sectional view 400B of the valve of FIG. 4A. The valve includes an inlet port 110, and outlet port 115 at the extremities of the conduit 105 of the valve. Near the inlet and outlet ports are threaded portions of the conduit, and a motor 125 is situated between the inlet port 110 and outlet port 115. The interior of the valve includes a rotor hub axle 182A, a magnetic rotor 170, a flow control element 485 fixed to the magnetic rotor 170, and a gasket 421 above the flow control element 485 that controls the flow through the valve. FIG. 4B shows a path of fluid flow 401 through the valve device.

FIG. 5 shows perspective cross-sectional view of the valve of FIG. 4B. In it, the modulation orifice 520 sits well below the outlet port 115 in the valve. The size of the modulation orifice 520 may be changed by the rotation of the flow control element 485. The magnetic rotor 170 of the motor 125 may move and in turn rotate the flow control element 485.

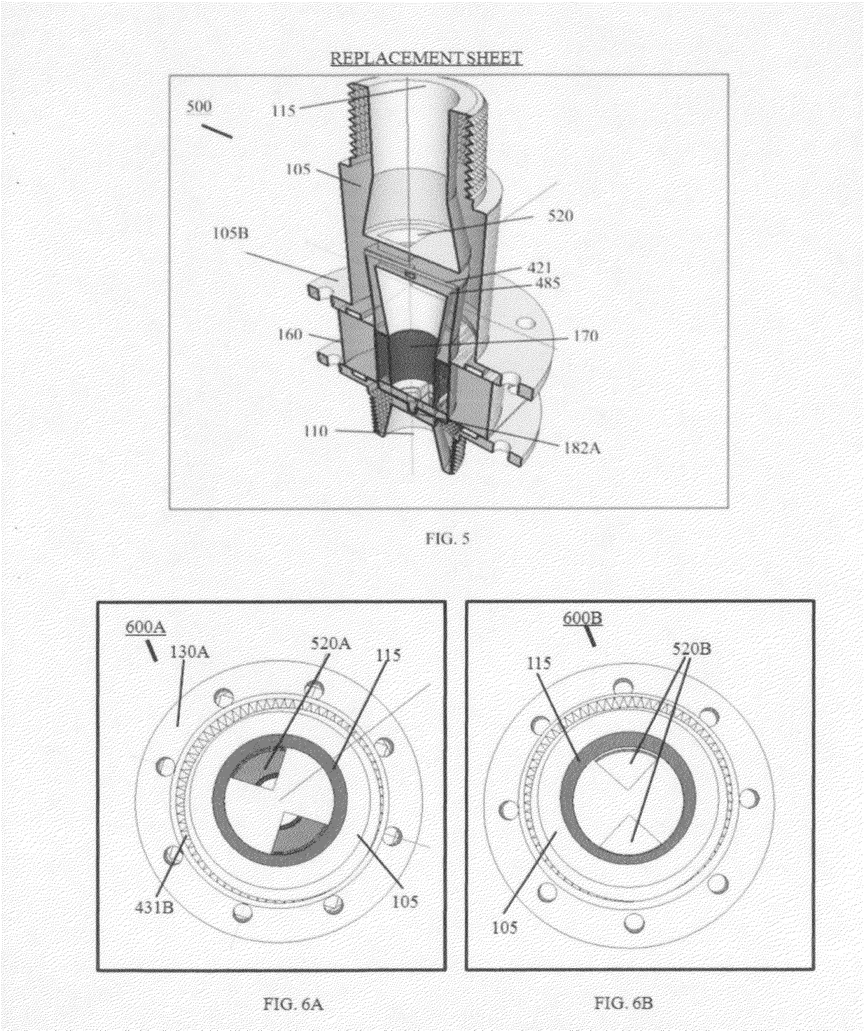

FIG. 6A and FIG. 6B show top down views 600A, 600B of the valve, respectively in the open and closed configurations. As discussed above, modulation of fluid flow through the valve may be affected by rotation of the flow control element 485, or expander, that may change the modulation orifice 520 opening area for the valve as the flow control element 485 rotates. The flow control element 485 may be configured to fully occlude the modulation orifice 120 in at least one position, and additionally to change the size of the modulation orifice 120 through a set of discrete, preset sizes or over a continuum of sizes from a maximum opening to a minimum opening (which can optionally be closed).

The valve components (except for the electrical motor parts) may be made from various materials, including corrosion resistant materials, for example plastics and any materials for mass-producing the non-electrical parts of the valve. To produce the non-electrical (e.g., non-motor components), methods such as injection molding, stamping, and the like can be used to mass-produce the components of the valve.

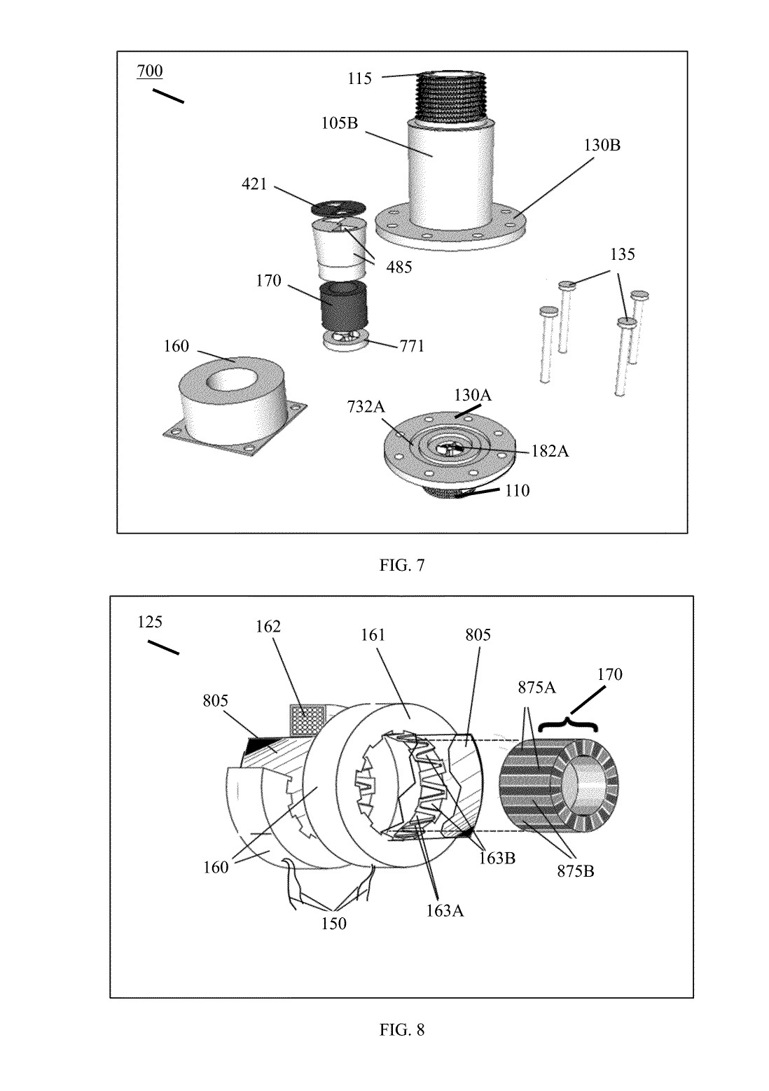

FIG. 4B, FIG. 5, and FIG. 7 show that the modulating device may include an electric motor whose magnetic rotor 170 is fixed to a flow control element 485. This flow control element 485 component may be situated in the conduit in the path of fluid flow. Rotation of the rotor and the connected flow control element 485 assembly may modulate flow of fluid through the valve. The flow control element 485 assembly may attach to the magnetic rotor 170 with the use of bonding materials such as epoxy, and/or mechanical means.

In the valves shown in FIGS. 1-7, the magnetic rotor 170 may include a permanent magnet structure situated in the valve so that fluid may flow through the motor unimpeded. The magnetic rotor 170 itself might be constructed of either or both permanent magnet and soft magnetic materials, and binding/fixing structures or adhesives. A magnetic rotor 170 can be formed of a ceramic magnet material and may have resistance to corrosion from the valve working fluid. The magnetic rotor 170 may be made of a material that includes magnetic stainless steel, NdFeB, ceramic, or other permanent magnet material that is also corrosion resistant. A bonded ring magnet, for example one that includes NdFeB particles magnetized and bound with epoxy or other binding material into a ring shape, may be used to fabricate the motor rotor. The magnetic rotor 170 may be any shape to allow fluid flow through the valve, including hollow, cylindrical, toroidal, channeled, or with holes. In use, the magnetic rotor 170 may be submerged into the working fluid, allowing the working fluid to pass through or around the motor rotor. The motor 125 and magnetic rotor 170 can include a conventional stepper motor of either the permanent magnet or hybrid magnetic (e.g., permanent magnet with soft magnetic materials) type.

FIG. 8 shows features of a standard “can-stack” stepper motor 125, such as may be used with the valves described above. Though the motor 125 has been described as a stepper motor with magnetic components, other types of motors may be used. The motors used in the valves described herein may include submerged rotors. One motor that may be used with the valves described herein is a hybrid stepper motor. A hybrid stepper motor has a rotor that includes of both permanent magnet material and soft magnetic materials. For example, a hybrid stepper motor may be used with magnetic stainless steel in its rotor. The motor 125 of FIG. 8 is shown in line with a cutaway conduit 805. The magnetic rotor 170 includes alternating magnetic north poles 875A and magnetic south poles 875B.

In some implementations of the current subject matter, the motor can be attached by wires 150 to an external power source (e.g. a means for energizing the motor) and current can be supplied to the stator 160 using any approach for motor electrical control. The motor stator itself may form a portion of the length of the overall valve conduit, where the toroidal shape of the stator 160 is typically potted (i.e., filled with a solid or gelatinous compound for resistance to shock and vibration, and for exclusion of moisture and corrosive agents) in an epoxy resin or other material that protects the stator 160 from corrosion of the working fluid. The valve working fluid can flow through the center of the toroid of the stator 160. The stator toroid can be dipped in epoxy resin, plastic dip, or it can be overmolded with injection molding processes. The toroidal shape of the stator 160 may allow fluid to flow through its center while the exterior of the stator remains dry.

The stator 160 may be located between the inlet port/conduit and the outlet port conduit, while flanges on both ports and the stator 160 may hold the parts sealed and together. Gasketing material, such as O-rings, may also assist in sealing the overall inlet port, outlet port, and motor stator together to form the overall conduit of the valve.

The conduit may include portions of the inlet and outlet ports that may facilitate including the valve into a piping network. For example, pipe threads, pipe “slip joints,” and the like can make up part of the ends of the valve conduit.

A modulation orifice 120, 520 through which the working fluid flows can be included in the conduit. The modulation orifice 120, 520 has a predetermined shape that is at least approximately matched to or otherwise configured to cooperate with a feature of the flow control element. In the example valve illustrated in FIG. 1 to FIG. 3B, the modulation orifice 120 is configured to receive a sealing end of the valve rotor gate assembly 180.

In the example valve illustrated in FIG. 4A to FIG. 7, the flow control element 485 and the modulation orifice 520 can each include one or more orifices that can be moved into greater or lesser alignment to change the size of the flow passage through the modulating orifice or can be fully offset to completely block flow through the valve. These orifices can be preferentially shaped such that magnitude of flow through the valve linearly relates to the amount of flow control element rotation, or can be shaped to create different relationships between flow volume and flow control element rotational position, in the case when there is a constant differential fluid pressure between inlet and outlet to the valve. Modulation orifices may be used to affect a desired dynamic flow control.

A low friction gasket 421 may attach at the interior top of the modulation orifice area (as in FIG. 5) or to the top of the flow control element. The low friction gasket may reduce rotational friction and/or assist in sealing the flow control element/modulation orifice interface. The gasket may be made of materials such as Delrin, PTFE, hydrophobic materials, and the like. This gasket may be omitted, resulting in raw material friction between the rotating flow control element and modulation orifice area.

The flow control element may be made of a plastic or other non-magnetic material. The flow control element may be bound to the motor rotor with adhesives or by other mechanical means so that it is fixed and moves as a solid body with the motor rotor. A small cylindrical protrusion (e.g., an axle) may be at the bottom of the modulation orifice plane that inserts or abuts into the magnetic rotor 170. This configuration may keep the flow control element assembly centered while turning within the motor stator.

In use, the magnetic rotor 170 may be situated in the flow of fluid through the valve conduit. Additionally, the magnetic rotor may be located in the valve where magnetic flux passes between the rotor and the motor stator. In this configuration, the working fluid of the valve makes up an appreciable portion of the magnetic circuit traditionally called an “air gap.” The working fluid gap may play a significant role as part of the overall magnetic circuit made up by the motor stator, rotor, and valve. The magnetic rotor may include a multi-poled magnetic ring such as is commonly found in stepper motors of the permanent magnet, hybrid stepper, or disk stepper types.

A non-magnetic material rotor hub, or axle, may also be solidly adhered or mechanically attached to the motor rotor to help keep the rotor centered with respect to the motor stator and to help maintain the axial position of the rotor/obturator assembly in the valve conduit.

Alternatively, or additionally, a cylindrically shaped hub that does not have any “spokes” that cross the entire fluid flow path across the rotor center may keep the rotor both centered and from moving axially downward. This cylindrical shaped hub may simply turn in a loose-fitting cylindrical groove near the inlet port. This configuration may streamline fluid flow through the valve as compared to a hub whose “spokes” impede flow at the center of the flow channel.

The motor stator 160 can be a conventional motor stator with copper windings and soft magnetic materials that help to spatially form the magnetic circuit created by the passage of electrical current through the windings. The motor stator may be a stepper motor stator and may have a detent torque that helps to hold the rotor in a stable rotational position by passive magnetic forces when no current is flowing in the stator coil windings. Any shape for the motor stator may be used to accentuate this detent holding torque to hold the rotor/obturator in a fixed position with passive magnetic forces as fluid flows through the valve.

As shown by the fluid flow path in FIG. 4B and by illustration of FIG. 6A, the valve may operate as a conduit where fluid enters the valve at the inlet port, flows past the “spokes” of the rotor hub, through the center of the toroidal rotor, along the interior of the cylindrical/toroidal stator, up through the obturator/expander, through the modulation gates (FIG. 4), then through the modulation orifices, and out of the valve outlet port when the valve is in use and in the open position. The rotor/obturator assembly may be held from rotating or held fixed in this open position by the passive magnetic detent, or “cogging” torque of the stepper motor magnetic rotor interacting with the stator motor “teeth.”

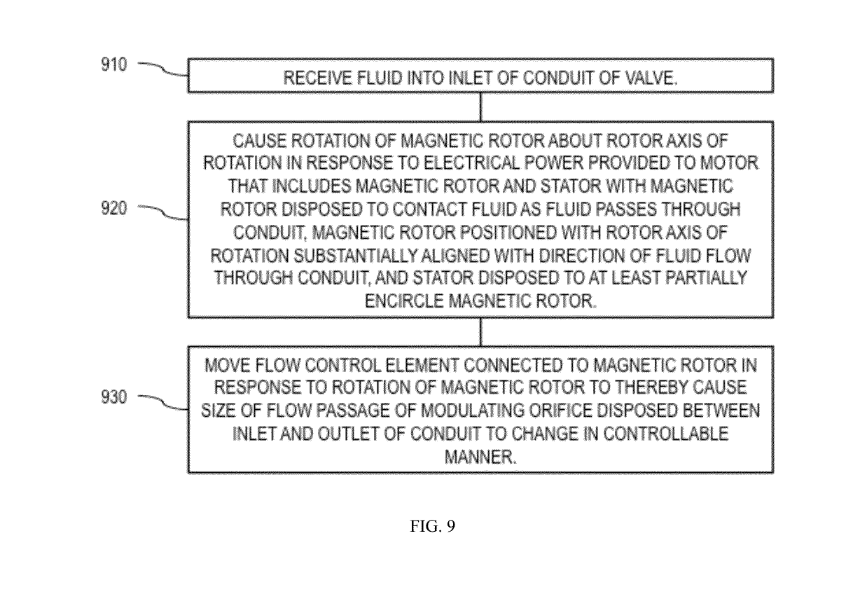

FIG. 9 shows a process flow chart 900 illustrating features that can be present in a method consistent with implementations of the current subject matter. At 910 a fluid is received into an inlet of a conduit of a valve. Rotation of a magnetic rotor about a rotor axis of rotation in is caused at 920 in response to electrical power provided to a motor that includes the magnetic rotor and a stator. The magnetic rotor is disposed to contact the fluid as the fluid passes through the conduit and also positioned with a rotor axis of rotation substantially aligned with a direction of fluid flow through the conduit. The stator is disposed to at least partially encircle the magnetic rotor, for example with a toroidal shape that is centered on the rotor axis of rotation. At 930, a flow control element connected to the magnetic rotor is moved in response to the rotation of the magnetic rotor. Movement of the flow control element causes a size of a flow passage of a modulating orifice to change in a controllable manner. The modulating orifice is disposed between the inlet and an outlet of the conduit.

Applying a stepper or other type of motor electrical current waveform to the motor stator lead wires may close the valve. The applied current may rotate the motor rotor in discrete steps until the modulation orifice reaches a desired size. Applying only one or a few steps to the fully opened obturator may result in only small angular rotations and, essentially, may open the valve orifice area in proportion to the angular rotation.

During rotation, the obturator rotationally may slide over the gasketed surface of the modulation orifice. A low friction gasket surface such as PTFE, acetal, or other similar or combined gasket materials can be used to both decrease this sliding (and starting) friction so that less energy is required to change the flow rate through the valve, as described above.

When the motor is no longer energized, the detent torque and/or friction of the obturator being pushed against the modulation orifice seating area by fluid pressure may hold the rotor in its last position. As the motor is inherently reversible, valve flow volume may be either decreased or increased by appropriately driving the electrical current waveform through the motor coil windings.

Though the valve motor has been described as a stepper motor, other electromagnetic motor types may be used. Stepper motors, particularly stepper motors with permanent magnets in them, may include components that may have very little friction, as well as exhibit a magnetic detent, or “cogging” torque that serves to hold the motor in its last set position when all power is removed. Stepper motors may be capable of discrete steps in rotation by passing an appropriate electrical waveform in to the lead wires of the motor. In this way, the valve may be actuated with very little friction and still hold its position when power is removed, rather than relying on the friction of a stem packing or other means of holding the valve in the set position.

Alternatively, or additionally, the motor and obturator may mount transverse to the valve conduit, but maintain a “wet” electromagnetic rotor, and may function similarly to implementations described herein. Further, the motor and obturator may create a different valve form factor from the embodiments shown and described herein, yet function in a similar manner to the valves described above.

The valves, systems, and method described herein that use a submerged electromagnetic rotor, may be advantageous when used in autonomous, remote, solar or hydroelectric-turbine powered, radio controlled valves that require no power or data communications wires that connect outside of themselves.

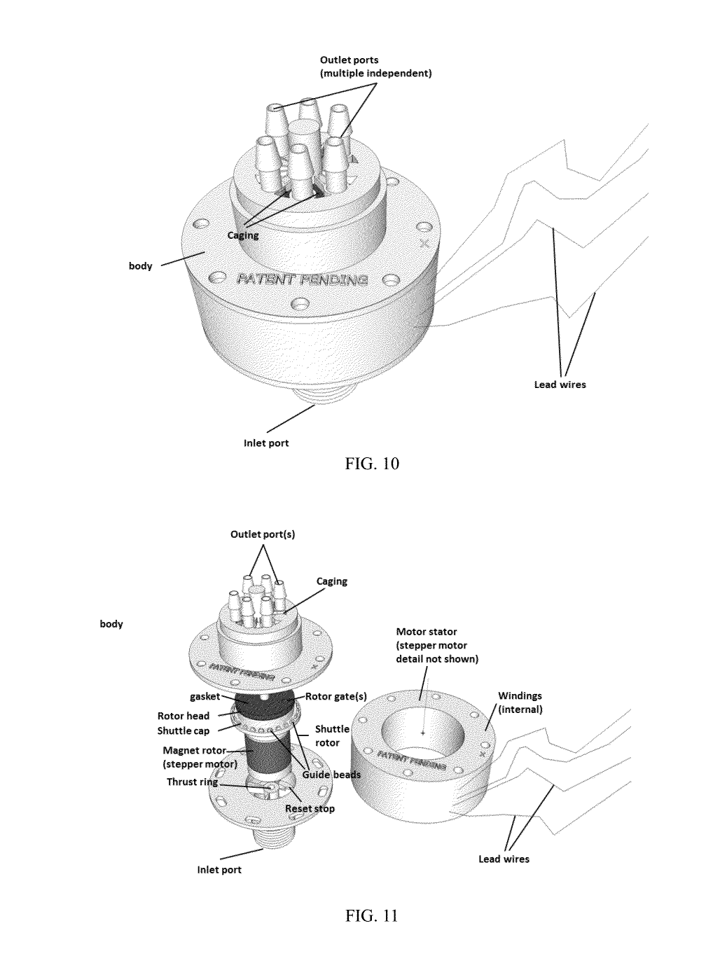

The description below includes implementations of the current subject matter that may be used with the valves, systems, and methods described above. In some example, implementations of the current subject matter include wet rotor caged modulation assisted valves. FIG. 10 is a perspective side view of an example of such a valve. The entire valve device is essentially axially symmetric except for a few minor attributes such as motor wire leads. It has a fluid inlet, and a fluid outlet.

There are two parts of the valve that move with respect to one another: the shuttle-rotor, and the valve body. The valve body is expected to be made primarily of injection molded PVC, ABS, or other common plastic material.

In this particular implementation, the shuttle-rotor is completely submersed in the working fluid (wet rotor). However, the magnetic portion of the shuttle rotor could be put on top of the caging area outside of the fluid flow. The shuttle-rotor includes, but is not limited in constitution to, a hollow cylindrical permanent magnet rotor and an attached hollow cylindrical shuttle cap. The permanent magnet rotor is of the type found in permanent magnet stepper motors such as those motors made by Portescap and commonly known as “can stack” permanent magnet motors.

Though typical can-stack magnets have a large number (e.g. 12 or 24) north/south magnetic striations running vertically and alternating around the cylinder perimeter, other magnet implementations may of as little as a single (bipolar) magnet. This might be the case where the valve was stepped only once forward, and once backwards to turn on and off a valve, by opening and closing the valve gates, respectively.

The hollow cylindrical center of the magnet rotor is intended as a channel through which the working fluid may flow. The magnet is magnetized with a plurality of alternating north and south poles around its circumference. Of particular note is that the magnet rotor is actually enclosed within the conduit of the valve and exposed to the working fluid. As the rotor is exposed to the working fluid, the material composition of the magnet rotor is typically ferrite, which is common corrosion resistant, and magnetic, but may be made from other materials. Other materials (such as neodymium or iron (reluctance motor)) would typically need to be coated or be implicitly resistant to the corrosive action of the working fluid. The magnet rotor may, as is common in the art, also have other soft magnetic materials distributed in predetermined geometries about its surface (not illustrated) to increase the efficiency of motor magnetic circuits. At one end of its cylindrical shape, the magnet rotor has fixed to it, a cylindrical shuttle cap. The shuttle cap material is typically comprised of a non-corrosive plastic but may prove more effective if comprised with other ferromagnetic materials that increase electromagnetic efficiency or improve an axial solenoid action of the shuttle-rotor. Other non-ferromagnetic materials may also be used. Enclosing the magnet rotor in the valve's conduit (and exposing it to the working fluid) constitutes a means of arranging the electromagnetic valve motor by which the present invention greatly reduces valve actuation forces by the elimination of a valve stem and associated packing (particularly eliminating the friction that is associated with a valve packing).

The rotor head portion of the shuttle cap is a layer of rigid, impervious plastic or similar material, that is rigidly attached to the shuttle cap. The rotor head is holes or is fenestrated with one or more segmented openings or orifices, herein referred to as rotor gates, in the head that span a prescribed shape with respect to their angular and radial extent. The purpose of said rotor gates is to enable fluid flow through the rotor head. A finite annular ring of impervious material exists on the outer circumference of the rotor head so as to enable the formation of a seal against a valve body seal. When no fluid pressure is applied to the valve inlet port, the rotor is at rest (or may be assisted by a small return spring in the upper axle thrust bearing—not shown) and a small gap exists between the cap and the valve body seal such that the entire shuttle-rotor may rotate inside of the shuttle body with minimal friction.

The valve body comprises, but is not limited in constitution to, the main valve body structure, an attached ferromagnetic can-stack stepper-motor stator containing magnet wire windings, winding lead wires, and a low-friction thrust ring upon which the magnet rotor rests (under zero fluid pressure). The valve body also has a fixed planar valve body seal spanning an area large enough to make a seal. The body seal area has one or more segmented openings or orifices of prescribed shape with respect to their angular and radial extent called body gates.

Importantly, the body seal area may be further segmented into a third type of area called caging or its caging area (inspired by the cage-like structure that gives rigidity but allows air (or water) to pass through. Caging is shown in the figure. The caging area is important in that it exposes a larger area of one side of the shuttle rotor head to ambient (typically atmospheric) pressure, while the other side of the shuttle rotor head is exposed to the pressure of the working fluid (assuming working fluid is admitted). The differential in pressure tends to assist the valve in making a stronger, and more definite, seal around the rotor and body gates, reducing valve seal leakage.

Overlap of body gates with rotor gates in the top of the rotor shuttle cap is the means by which the valve modulates fluid flow per outlet. A few small additional openings (also known as caging) appear in the body seal, but are not matched in the rotor head. The purpose of inclusion of said ancillary openings is to ensure a definite pressure seal of rotor head to body seal under pressurized operation of the valve. Pipe threading is shown in the drawing at the inlet of the valve, but is ancillary, or not necessary, as fixing the valve to external piping may entail various means of fastening including PVC pipe glue, integral molding into another device, or other means. Gasket material is typically applied to the underside (bottom) of the body seal surface, except in regions of the body gates (modulation orifices) and, potentially, in regions of ancillary holes within the body seal. A reset stop is attached to the valve body and protrudes up into the hollow cylinder of the shuttle-rotor. A rotor stop is attached to the inside cylinder wall of the shuttle rotor. The reset stop and rotor stop exist for the purpose of enabling rotation of the shuttle-rotor to its reset, or zero degree, absolute position.

The can-stack stator may be integrated with the body by various means. During the manufacturing process, the entire stator and windings assembly might be completely encased with a molten thermoplastic block of larger dimension than the stator assembly itself. After the plastic solidifies, the block may be drilled through the interior cylindrical part of the stator with a precision drill, thus forming the cylinder in which shuttle-rotor resides while also forming the main body of the valve. As shown, a stepper motor stator might also be “plastic dipped” or epoxy coated and the overall inlet and outlet regions of the valve (and its core parts) be sandwiched and fixed with fasteners around the outside of the stator (as shown, without fasteners/bolts). In either case, further adjustment of the bore diameter might further use an abrasive removal of some material with emery or sandpaper fixed to a drill or manually applied so as to create a tight tolerance magnetic gap between magnet rotor and stator. This boring, however, would be unnecessary if the stator and magnet were fixed outside of the valve near the center axis in the caging area. If the stator and magnet were fixed outside of the conduit and on top of the caging area, a smaller rotational travel might be had due to impingement of structure where the magnet was fixed to the rotor cap upon some of the caging structure.

Regardless of the means of attachment, the stator and valve body, in this implementation, integrally form the valve conduit cylinder in which magnet rotor turns. As an aside and in another implementation, however, the stator could sit on top of the caged area and the magnet, attached at points to the top of the rotor hear, could protrude through openings in the caging. In the current implementation in which the stator and valve body integrally form the valve conduit cylinder in which magnet rotor turns, the thin layer of material between stator and rotor is thick enough to withstand leakage of the pressurized working fluid into the stator yet is as thin as possible to minimize the reluctance of the magnetic path between the stator and the magnet rotor. It is also thin enough to enable the free rotation of the shuttle-rotor with minimal frictional resistance.

The four magnet wire leads shown in FIG. 10 imply a two-phase bipolar stepping configuration, but other phase and polarity motor configurations, such as are common in the art of electric motors, may be alternatively employed. A return coil spring may prove useful if attached at one end to the bottom of the shuttle-rotor and at the other end to the valve body near the inlet port. Passive magnetic forces and/or gravity is expected to hold shuttle-rotor to its rest position against the thrust ring.

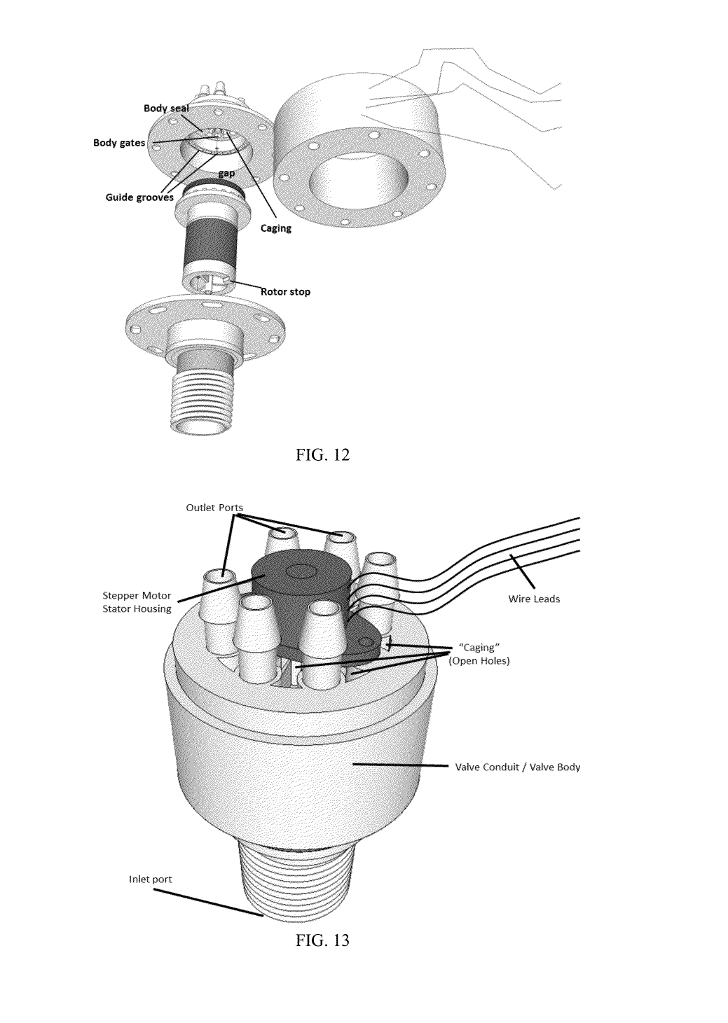

FIGS. 11 and 12 show perspective side views of an implementation of the shuttle-rotor assembly, exploded from the valve body. It can be seen here that, in most respects, this modulation assisted valve (MAV) implementation generally adheres to the structure and behavior disclosed in the second implementation disclosed in International Patent Application PCT/US14/15641, Process and System for Controlling Modulation Assisted Valves for the Internet of Things (FIG. 10 of the International Patent Application).

In an alternative implementation, the interior wall of the body might exhibit multiple recessed guide grooves running helically up the interior wall of the body. The rotor cap, too, might then have a guide protrusion on its outer perimeter that slid in the guide grooves, such that, under admittance of fluid pressure, the rotor cap would spin up into the body “riding” in these guide grooves, to come to rest seated, at a predetermined angle and sealing against the body gates. The beginning of the guide grooves could be open, allowing which guide groove was engaged to be set, while under zero fluid pressure, by rotating the rotor to a specified starting angle. Different starting angles would correspond to different final rotor angles (hydraulic positions) that were engaged after pressure was admitted to the device.

The operation, also, of the wet rotor caged MAV is adheres to the operation of the second MAV implementation disclosed in International Patent Application PCT/US14/15641, Process and System for Controlling Modulation Assisted Valves for the Internet of Things (FIG. 10 of the International Patent Application). Here, however, when fluid is admitted to this caged MAV, the caging structure tends to increase the magnitude of the positive pressure seal force of the gating mechanism (obturator) against the body gates (modulation orifices). This is due to the caging structure exposing a greater area of the gating mechanism to the pressure differential between the working fluid inlet and ambient, thus creating a greater valve sealing force.

As with many MAVs, this implementation may be provisioned with energy harvesting electronics, electrical capacitive or battery energy storage, and radio controlled communications to make a combined, low-energy, completely wireless and energy autonomous valve.

FIG. 13 is a perspective side view of another implementation of the current subject matter. The entire valve device is essentially axially symmetric except for a few minor attributes such as motor wire leads. It generally forms a conduit with a fluid inlet port at one end that can be threaded, and multiple fluid outlets at the other end. The outlets are mounted near a mesh or structural “caging,” where the caging is open to the top of a fluid gating mechanism (obturator). The open caging serves the purpose of exposing a large area on one side of the gating mechanism to ambient pressure so as to multiply the net force exerted on the gating mechanism by fluid pressure imposed on the other side of the gating mechanism, the latter of which being exposed to the internal pressure within the valve conduit.

FIG. 13 further shows a stepper motor mounted outside of the conduit on top of the caged area. The stepper motor is in rotational communication with a rotating gating mechanism (an obturator which is also referred to, herein, as a “shuttle rotor” and is hidden in FIG. 13). Each of the fluid outlets shown in FIG. 13 can be independently controlled by virtue of control signals that are sent to the stepper motor through the shown wire leads. The wire leads carry both control and power signals and essentially provide a means of accepting a time-varying electrical energy signal for actuation of the valve by rotating the gating mechanism.

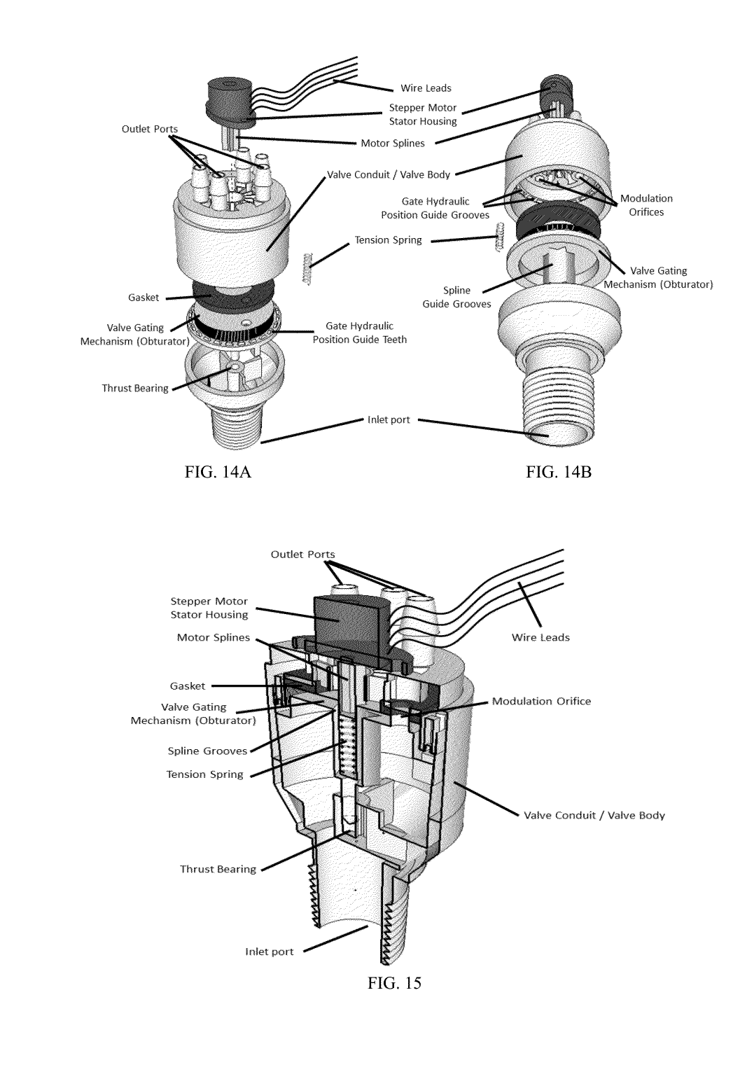

The top exploded perspective view of FIG. 14A further shows the structure of the dry rotor, caged implementation of a MAV. The figure shows the circular valve gating mechanism (obturator, or “shuttle rotor”) and its gasket, in this embodiment, with a single hole through it near the circumference. This shuttle rotor has multiple hydraulic position guide teeth around its perimeter that assist in guiding the movement of the rotor to a seated hydraulic position by the teeth sliding into multiple gate hydraulic position guide grooves (shown in the bottom exploded perspective view of FIG. 14B), when pushed by fluid pressure from underneath the shuttle rotor.

There are two parts of the valve that move with respect to one another: the shuttle-rotor, and the valve body. The valve body may be made primarily of injection molded PVC, ABS, or other common plastic material.

In this particular implementation, the magnetic portion of the shuttle rotor is on top of the caging area outside of the fluid flow and takes the form of a self-contained stepper motor. The stepper motor is of the permanent magnet stepper motor types such as those motors made by Portescap and commonly known as “can stack” permanent magnet motors. This motor can be very small, and be a low torque and low energy motor.

FIG. 14A and FIG. 14B show that the stepper motor has splines, or a spline gear, attached to its drive axle in a vertical orientation. The splines insert into and are able to slide vertically in spline guide grooves that are shown as part of the shuttle rotor (valve gating mechanism).

An elongated hollow cylinder forms a thrush bearing in the base of the valve body, in which an axle on the shuttle rotor may turn, while, at the same, time, be enable the shuttle rotor to move vertically such as when fluid pressure pushes it upward.

A tension spring (shown exploded off to the side) can be inserted into the spline guide groove void such that, when the motor splines are inserted into the grooves and on top of the spring, the shuttle rotor is preferably pushed down (in the absence of fluid pressure), unseating the shuttle rotor from the valve modulation orifices (shown in FIG. 14A and FIG. 14B).

Though typical can-stack magnets have a large number (e.g. 12 or 24) north/south magnetic striations running vertically and alternating around the cylinder perimeter, other magnet embodiments may of as little as a single (bipolar) magnet. This might be the case where the valve was stepped only once forward, and once backwards to turn on and off a valve, by opening and closing the valve gates, respectively.

Attaching the motor in such a way as shown allows a significant reduction in valve actuation forces by the elimination of a valve stem and associated packing (particularly eliminating the friction that is associated with a valve packing) When pressure is removed from the inlet port, the spring will disengage the guide teeth of the shuttle rotor from the hydraulic guide grooves. The axle of the shuttle rotor (shown inserted into the thrust bearing of FIG. 15) will come to rest in the thrust bearing of the valve body, enabling the shuttle rotor to spin freely under the power of the stepper motor torque applied through the spline gear.

The rotor head portion of the shuttle cap is a layer of rigid, impervious plastic or similar material that is rigidly attached to the shuttle cap. The rotor head has holes or is fenestrated with one or more segmented openings or orifices, herein referred to as rotor gates, in the head that span a prescribed shape with respect to their angular and radial extent. The purpose of said rotor gates is to enable fluid flow through the rotor head. A finite annular ring of impervious material exists on the outer circumference of the rotor head so as to enable the formation of a seal against a valve body seal at the modulation orifices. When no fluid pressure is applied to the valve inlet port, the shuttle rotor is at rest (or may be assisted by a small return spring) and a small gap exists between the cap and the modulation orifices such that the entire shuttle-rotor may rotate inside of the shuttle body with minimal friction.

The valve body comprises, but is not limited in constitution to, the main valve body structure and a low-friction thrust ring upon which the shuttle rotor rests (under zero fluid pressure). The valve body also has a fixed planar valve body seal spanning an area large enough to make a seal. The body seal area has one or more segmented openings or modulation orifices of prescribed shape with respect to their angular and radial extent called body gates.

Importantly, the body seal area may be further segmented into a third type of area called caging or its caging area (inspired by the cage-like structure that gives rigidity but allows air (or water) to pass through. Caging is shown in the figure. The caging area is important in that it exposes a larger area of one side of the shuttle rotor head to ambient (typically atmospheric) pressure, while the other side of the shuttle rotor head is exposed to the pressure of the working fluid (assuming working fluid is admitted). The differential in pressure tends to assist the valve in making a stronger, and more definite, seal around the rotor and body gates, reducing valve seal leakage.

Preferential overlap at each of the outlet ports' modulation orifices (body gates) with rotor gates in the top of the rotor shuttle cap is the means by which the valve modulates fluid flow through the outlet ports. A few small additional openings (also known as caging) appear in the body seal, but are not matched in the rotor head. The purpose of inclusion of said ancillary openings is to ensure a definite pressure seal of rotor head to body seal under pressurized operation of the valve. Pipe threading is shown in the drawing at the inlet of the valve, but is ancillary, or not necessary, as fixing the valve to external piping may entail various means of fastening including PVC pipe glue, integral molding into another device, or other means. Gasket material is typically applied to the underside (bottom) of the body seal surface, except in regions of the body gates (modulation orifices) and, potentially, in regions of ancillary holes (caging) within the body seal. A reset stop is attached to the valve body and protrudes to stop cylinder of the shuttle-rotor from rotating past a zero degrees rotational position. A rotor stop is attached to the cylinder of the shuttle rotor as a complement for the same purpose. The reset stop and rotor stop exist for the purpose of enabling rotation of the shuttle-rotor to its reset, or zero degree, absolute position.

The four magnet wire leads shown in FIG. 13 imply a two-phase bipolar stepping configuration, but other phase and polarity motor configurations, such as are common in the art of electric motors, may be alternatively employed. A return coil spring may prove useful if attached at one end to the bottom of the shuttle-rotor and at the other end to the valve body near the inlet port. A spring and/or gravity is expected to hold shuttle-rotor to its rest position against the thrust ring.

It can be seen here that, in most respects, this modulation assisted valve (MAV) implementation adheres, in many ways, to the structure and behavior of the second embodiment disclosed in International Patent Application PCT/US14/15641, Process and System for Controlling Modulation Assisted Valves for the Internet of Things (FIG. 10 of the International Patent Application).

Here, however, when fluid is admitted to this caged MAV, the caging structure tends to increase the magnitude of the positive pressure seal force of the gating mechanism (obturator) against the body gates (modulation orifices). This is due to the caging structure exposing a greater area of the gating mechanism to the pressure differential between the working fluid inlet and ambient, thus creating a greater valve sealing force.

In the implementation of FIGS. 12-14, when pressure is admitted at the inlet port, the gating mechanism (or shuttle rotor) moves vertically to its seated position against the modulation orifices, much like the embodiment in the PCT application, while also sliding vertically along the spline gear of the stepper motor.

In addition, because of the way in which motor is mounted, the motor may be manufactured as a separate and independent element that takes advantage of the many years of engineering, manufacturing, materials, cost optimizations, and other advantages that can be had by utilizing an independently manufactured, “off-the-shelf,” stepper motor.

A with other MAVs, this implementation may be provisioned with energy harvesting electronics, electrical capacitive or battery energy storage, and radio controlled communications to make a combined, low-energy, completely wireless and energy autonomous valve.

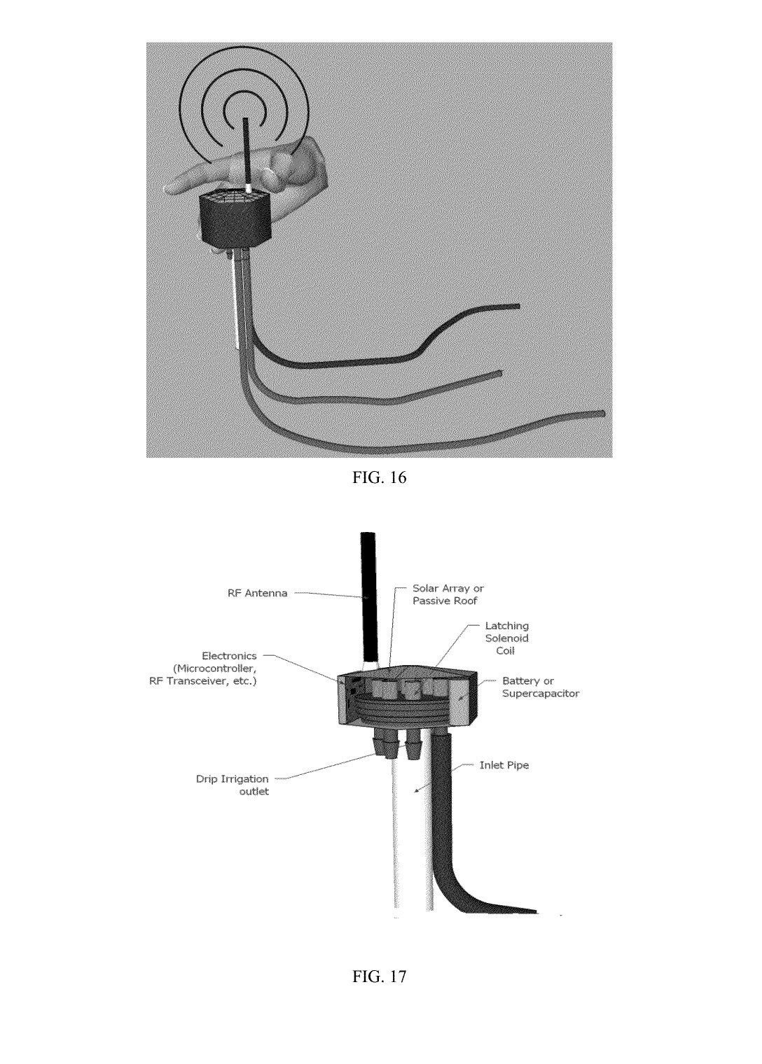

It can be seen that the cage valve discussed above can also be used, interchangeably, with the MAV gating mechanism (“pinwheel”) shown as the Sixth MAV Embodiment—FIG. 16-FIG. 17 of International Patent Application Number: PCT/US14/15641, Process and System for Controlling Modulation Assisted Valves for the Internet of Things, that was disclosed there by the present inventor.

In another alternative embodiment, instead of having guide grooves recessed into the top of the device, the interior wall of the body might exhibit multiple recessed guide grooves running helically up the interior wall of the body. The rotor cap, too, might then have a guide protrusion on its outer perimeter that slid in the guide grooves, such that, under admittance of fluid pressure, the rotor cap would spin up into the body “riding” in these guide grooves, to come to rest seated, at a predetermined angle and sealing against the body gates. The beginning of the guide grooves could be open, allowing which guide groove was engaged to be set, while under zero fluid pressure, by rotating the rotor to a specified starting angle. Different starting angles would correspond to different final rotor angles (hydraulic positions) that were engaged after pressure was admitted to the device.

It is easy to see that provisioning this and other MAV valve implementations, with the energy harvesting (solar, hydro-electric micro-turbine, etc.), power storage (battery, capacitor, etc.), microcomputer (microcontroller with clock, etc.), and radio frequency transceiver is a matter of standard electronics arrangement, interconnection, packaging, and, possibly, potting. Obviously, such an exercise would strive to minimize electronics parts cost, layout area, resistance to environmental (e.g. water) damage, and energy harvesting optimization (e.g. putting a solar array on a disc, connected to, but above, the valve to expose optimal light collecting area) and power conservation.

FIG. 16 is a drawing of an implementation of the current subject matter shown in the presence of a human hand to give scale perspective. The device is has a conventional water inlet at the bottom, six internal solenoid plungers, and six barbed outlets to which drip irrigation piping can be fixed. Here, the number six is arbitrary, as the device can be equally well realized with N solenoids and N outlet ports. The device is shown covered with solar cell material for collecting its operational power from the ambient environment. However, other means of local or remote power may be employed. A radio frequency antenna is shown on top (with artificial hemispherical radio wave indicators), indicating that the device may be wirelessly controlled. However, wireless control is not necessary, and the device may be controlled over wires as well. Only three (of the six potential) drip tubes are shown connected to the device, with the colors red, green, and blue simply indication independent control of each irrigation outlet. The device is primarily made of plastics such as PVC and/or ABS with copper wiring for the solenoid coils and magnetic stainless steel used for the solenoid plungers.

FIG. 17 shows a more detailed view of the internal workings of the device. An irrigation water inlet pipe and multiple (six, in this case) outlet irrigation ports are shown, the latter being arranged in a circular or radial pattern. Six solenoid coils are shown, which activate solenoid plungers to open and close irrigation orifices for each of the independent irrigation outlets (six being an arbitrary number, in this case) thus controlling water flow between the inlet pipe and multiple outlet ports. The figure also shows the possible addition of on-board control electronics with microcontroller and power management electronics which are used for controlling RF communications and for solenoid actuation control. A vertical RF dipole antenna is shown to be used for RF communications, but a printed circuit board (PCB) or small ceramic antenna may suffice depending on the range and RF signal quality required. A solar array for harvesting operational power from the environment is shown, as is one or more supercapacitors, the latter being used for energy storage. Herein, the singular forms of the words “supercapacitor” and “battery” will be understood to be optionally equivalent to their plural forms (“supercapacitors” and “batteries”).

The arrangement of the outlet ports might be linear rather than circular or radial. In that case, the device would essentially appear as an “unrolled” version of the radial configuration that is under present discussion.

The solenoids are of the latching, or bistable type, such that the only energy required for actuation is applied during the state transitions between open and closed. These solenoids possess a “holding” magnet in addition to their plunger and copper wire coil. A positive pulse of electrical current applied to each of the independent solenoids opens an outlet port and a negative pulse of current closes the port, which then stays in that position (assisted by the holding magnet) until further current pulses are applied. The sizes of the orifice holes obscured by the solenoid plunger are calculated so as to allow for a desired water flow volume rate in the open position and while under a specified fluid pressure. The pressure and orifice opening area also determine the amount of force required to open the solenoid plunger, thus enabling the amount of electrical current for opening the port to be calculated. If used on-board the valve, power control electronics would be employed most likely in the form of a voltage boost regulator to first boost the storage voltage to a higher value and temporarily store charge at the higher voltage in a boost capacitor. The boost capacitor would then be discharged, under control of the microcontroller, through an H-bridge (or similar electrical circuit) and through the solenoid coil to affect actuation of the solenoid plunger.

Further energy storage in the form of a battery and supercapacitor are shown in FIG. 17, but as noted, the valve may be controlled externally by wire where, in that case, no energy storage or on-board electronics are used (except that solenoid coil wiring is required). The figure also shows how control electronics, such as a microcontroller and power management electronics, can be collocated with the device. However these electronics are not necessary if the device is controlled over wire by an independent controlling entity that supplies both logic and power for valve actuation.

Where on-board power supply and control electronics are implemented, they would be electrically connected so as to supply the logic and power to independently actuate each of the N solenoids. An energy budget would be devised so that the appropriate area of solar cells and size of the electrical power storage device (battery, supercapacitor, etc.) may be calculated. Factors such as average earth insolation parameters, expected cloud cover profiles, obscuration of the sun by foliage, control electronics power consumption, radio power consumption, valve actuation power consumption, etc., may be employed for such calculations.

Similarly, if radio control is implemented, a power budget for such function must be determined using such factors as the radio range required, frequency of message communications, multi-hop message routing or networking schemes (multiple of the present invention may be used to communicate in a wired or wireless networked environment), geometric RF energy propagation (through walls, trees, hills, etc.) as well as quiescent circuit power requirements. If employed, a frequency band for industrial, scientific, and medical (ISM), such as the IEEE 802.15.4 specification would most likely be employed.

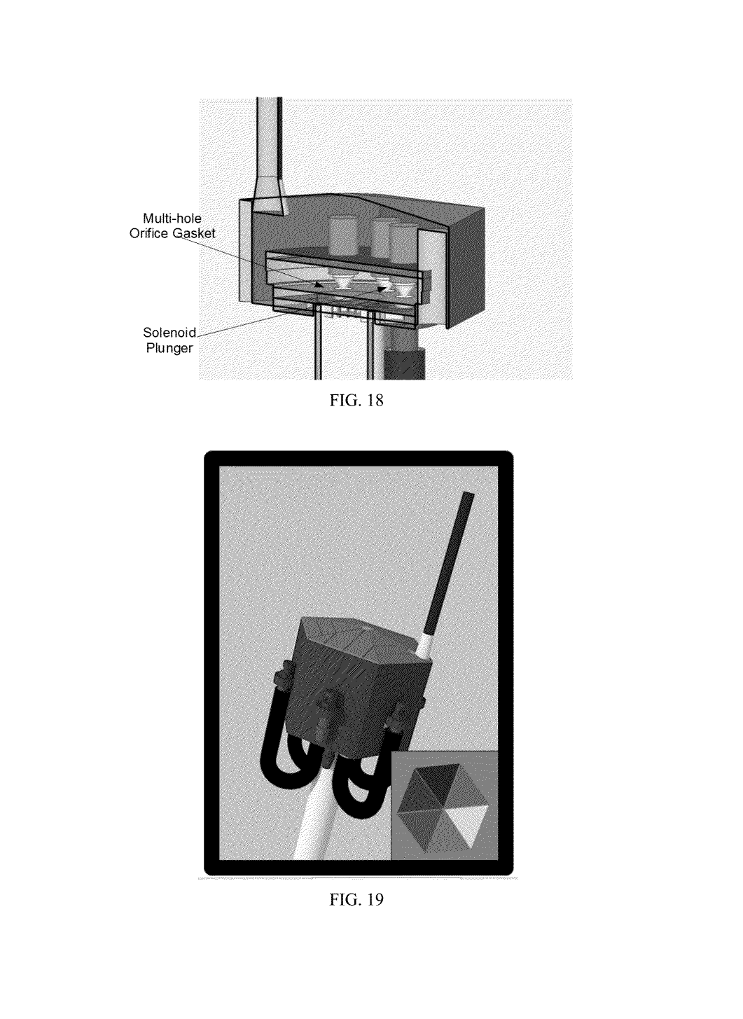

FIG. 18 shows a “cut-away” view, further detailing the solenoid plunger (with pointed or conical end shape) and a gasket surface to ensure a water-tight seal of each irrigation port while the solenoid plunger is in the closed position.

The device may manufactured using standard techniques for manufacture of similar parts such as standard pilot-operated irrigation solenoid valves, where PVC and ABS plastic injection molded parts host an encapsulated solenoid plunger, and copper coil windings, which are fluidly isolated from the plunger, are wound around a plastic cylinder water barrier.

The electronic and energy storage parts (if employed as collocated with the device) can be built using standard printed circuit board (PCB) techniques and can be mounted in a waterproof cavity connected and contiguous with the valve housing.

The manufacture of simple solenoid plungers (e.g., made of magnetic stainless steel) is well known in the art of metal working.

FIG. 19 shows an implementation of the invention in which microsprinkler mounts are integrated (could be part of a the injection mold for the housing) with the valve manifold so that a drip application can be easily turned into a spraying sprinkler application by attaching microsprinkler nozzles to the fixtures at the outside of the manifold and connecting these with drip tubing to the respective drip outlets. The outlets could then be individually controlled, as described herein, yielding a controlled spray pattern that is shown as the multi-colored thumbnail image inset to FIG. 19.

In its simplest form, the device need not include on-board electronics or energy storage, and the only electrical aspect of the device is the inclusion of multiple (N) copper wire coils, each of the N coils having a pair of wire terminal ends or contacts. In this case, any one of the irrigation outlets is opened by an external controller by the application of a pulse of current of given or polarity (or current direction) to the outlets corresponding solenoid coil. The same irrigation outlet is then closed by the application of a current pulse of opposite polarity. Each of the N irrigation outlets may be similarly controlled by applying a similar current pulse to the outlets respective solenoid coil.

In a more sophisticated case where the device is comprised of the aforementioned multi-coil valve manifold and includes additional on-board electronics (microcontroller, radio frequency transceiver, energy storage, and potentially energy harvesting parts such as one or more solar cells) and is controlled over a wireless RF link, many means of use and control may be described. The preferred approach is to acknowledge an independent and external radio frequency (RF) controller that sends an RF command to the radio of the present invention to open or close any combination of the N irrigation outlet ports of the device. Further discussion of one approach to device use and operation follows.

Referring to the implementation in FIG. 17, one or more solar cells supply current that is then stored in the shown supercapacitor. Calculations show that no chemical battery is required for the device if it is operated with attention to the power resources available. With little or no power conditioning the supercapacitor is expected to directly power the electronics package, including the microcontroller that can operate on as little as 1.8 volts or less. A voltage booster circuit is used to efficiently supply power for the current waveforms for electromechanical actuation of valve by the application of current pulses to the solenoid coils.

This implementation of the current subject matter may be physically installed nearly as any other drip irrigation device such as a standard drip irrigation manifold. The entire device is set in place the inlet port is attached to a water supply and can advantageously be oriented such as to optimize the antenna gain (reception and transmission) by pointing it in the direction of any external wireless devices with which the device is to communicate.

It is expected that the supercapacitor or lithium-ion capacitor of the device will, at installation, posses zero charge. Therefore, the device might be designed to be connected to an external host universal serial bus (USB) device (such as a smart phone or tablet computer) through a USB port.

The supercapacitor in the figure will then begin to be charged by the host USB power source up to a point where it reaches is maximum allowed voltage (currently expected to be 2.7 volts). Alternatively, the device may be initially charged from the solar cell, but the amount of time required for the supercapacitor to reach full charge will be much longer. In either case, after initial setup, the solar cell will continue to charge energy storage device (batteries, supercapacitors, etc.) which, in turn, will supply all energy required to operate the device. Other implementations of this valve may include small water-turbine generators mounted in the valve flow path, or similar, in place of the solar cell from which to harvest the energy necessary for device operation. During the initialization charging process, after the supercapacitor reaches a predetermined threshold voltage as seen by the microcontroller, the microcontroller executes behavioral steps encoded in its firmware program memory. An outline of one realization of that program is described below.

Most typically, the invention will be initially charged and logically initialized by means of interacting with a computer program in a USB-connected, Geographic Positioning System enabled (GPS-enabled), portable device such as a smart phone or portable computer. The connected program will load and update any new operating firmware into the sprinkler microcontroller and perform some basic initialization functions. Importantly, as part of the initialization process, GPS coordinates will be downloaded from the portable computer to the firmware in the sprinkler valve to enable the precise geolocation of the device. The device will most probably store the downloaded geographic coordinates into its non-volatile memory so that they can be later recalled by the device for local operation or sent to an external controller when commanded over the wireless link.

The execution of microcontroller firmware begins with the reset/initialization firmware program. After basic microcontroller hardware logical configuration, the firmware program utilizes a predetermined underlying public or custom wireless protocol (such as Zigbee or a custom protocol) to negotiate connection to and join with a IEEE 802.15.4 (or similar) based wireless personal area network (WPAN). The device then publishes its ability to communicate over the network. A wired connection could also be used for all of the above.

The device may be commanded by a remote, external, device over the wireless communications channel, over a wired communications channel, or it even may be commanded over a collocated electrical connections (such as an SPI bus with interrupt line) by a control processor that is collocated with the device.

As the device harvests such a small amount of energy from its environment, its logical and physical operation is primarily defined in terms of small, low energy, discrete events and state changes. When the device is not executing one of these small state transition events or while it is not managing or actuating one of the small state changes, the device will remain in a low-power sleep state. It is expected to be in this sleep state most of the time, again, for the purpose of conserving energy.

Commands sent by the external controller are in the form of commanded discrete events that change the physical and/or logical state of a device consistent with one or more implementations of the current subject matter. Commands are managed by an internal event queue which stores command events in an essentially time-stamp-ordered sequence such that the oldest time-stamp command is executed first and the most recent time-stamp command is moved to the back of the queue to be executed later. Exceptions to this time-ordered queuing exist such as when the device encounters an error condition (e.g. low power, or similar) where internally generated events may be serviced before externally commanded events.

Messages may be sent and received by the device over said wireless or wired communications channel, to:

request (transmit) that commands be sent by the external controller;

receive commands to synchronize device internal clock/timer with a commanded time stamp;

receive commands to report execution status of previous commands and events;

transmit status reports of previously executed commands and events;

receive commands to cancel or modify previous commands;

receive commands to enable alerts or exceptional conditions;

receive commands to schedule wireless communications slot times for accepting future commands from outside the system, including:
receive scheduling commands for zero or more start times for said communications slots;
receive scheduling commands for termination of communications time slots;

receive commands to schedule zero or more “set valve” events, the parameters of such commands taking the form of:
time for each of said “set valve” event for each of the N said solenoid coils;
the “on” or “off” setting for said “set valve” event;

receive commands to schedule zero or more “set sleep state” events, the parameters of such commands taking the form of:
time for each of said “set sleep state” event;
state indicator for each said “set sleep state” event.

This list of commands is not, by any means, exhaustive, necessary, or exclusive. A sequence of multiple command events may also be wrapped in a single, parent, command. The parameter for said “set valve” event command would typically be a simple “on” or “off” command (and timing of such) for one or more of the N solenoid irrigation outlets.

The state indicator parameter for said “set sleep state” event command would include such state indicators as “sleeping”, “awake”, and “idle.” Sleep states, too, could potentially be customized by the external commanding application protocol. The allocation and synchronization of time slots for communications is common in various wireless networks and are often described as beacon networks.

After receiving commands from the controlling device, a valve consistent with one or more implementations of the current subject matter can synchronize its clock-Calendar with the commanded time stamp. It can then store all command events and their parameters, including scheduled communications intervals into on-board non-volatile memory, and store all of above said commanded scheduled “set valve” events commands into on board non-volatile memory. Other commanded events would also be stored in memory and ordered in the command event queue.

Internal scheduling of “set valve” event times can then be performed for each of the commanded “set valve” events and would do similar for communications time-slot intervals. If the current time was within one of the commanded communications time slots or was near in time to one of said “set valve” events, it would remain in the awake state and execute such “set valve” event command or communication command.

Received commands can be essentially commands for the device to change its state. Thus, several essential states can be included (although other, intermediate, ancillary or “housekeeping” states such as “idle” might also be used). Each defined state may be independent, dependent (sub-state), and/or combined with other states. In summary, the currently envisioned states comprise such states as follows. Indentations connote sub-states of a parent state.
Awake State
   Communicating
      Receiving commands
      Transmitting status
   Not communicating
   Actuating solenoid
   Open/Close state of all N solenoids
   Other states
   Other transient states (sometimes classified as events which move device from one state to next)
Sleep state
   Not communicating
   Open/Close state of all N solenoids
   Other states
Events that are primarily scheduled by external commands (as discussed above) serve to transition the device from one compound state to another.

A response to the “set time” command can include re-setting an internal clock to the commanded time stamp.

The following outlines the logical steps for implementations of the current subject matter to execute the externally commanded “set valve” command. For the physical means of actuation the solenoid actuated drip irrigation manifold, see previous discussion.

To execute the commanded “set valve” event, the microcontroller in this embodiment would first schedule a “wakeup” event at the commanded “set valve” event time and wake up from its low power sleep state at such time by means of a timed microcontroller interrupt. It would read the present state value for the valve setting stored in non-volatile memory and, if different from the commanded value, would actuate the valve to the N solenoids open/close settings parameter of the current “set valve” event. It would then store the new valve setting in non-volatile memory as a part of the device's currently defined state.

Irrigation fluid would then flow through each outlet port dependent on this setting and dependent up on the pressure applied at the overall device inlet. Each solenoid may be operated whether pressure is applied or not at the device inlet.

After setting the valve, the microcontroller would then schedule the next commanded event (which would typically be an event to turn off the valve (set the valve to zero flow), leave its flow setting unchanged (identical), or to schedule a wireless transmission request event to schedule a dialog with the controller, potentially through another “router” RF link, or other event). What type of event is next scheduled is, for the most part, externally commanded by virtue of the previously discussed event command messages. The device would then put itself into the power-saving “sleep” state, awaiting a sleep interrupt at the time of the next scheduled command event.

Other externally commanded events are primarily for the purpose of communicating with the external controller. Definition for the exact process of executing commands such as negotiating communications channels, scheduling communications time slots with the external controller, or reporting device status are primarily the role and responsibility of the external controller and such communications protocols are typically considered to be made up of elements that can be assembled as needed by one of ordinary skill in the art. Still, the lower layers (in an ISO sense) of this inferred device/controller communications protocol can be motivated by the constraints imposed by the limited energy that can be harvested by the current invention in its deployed environment. A possible mode of operation of implementations of the current subject matter within a larger system can include harvesting energy, standing by awaiting further commands from a controller, and efficiently executing such commands to actuate the solenoid plungers of the current embodiment. The precise definition of a command and communications protocol is deferred to such controller. Other housekeeping events such as re-setting the valve to its closed (or open) position may also be exercised independently from the external controller.

Manufacture of the implementations of the current subject matter can be accomplished within the capabilities of persons skilled in the art in light of the current disclosure and can advantageously involve creation of the valve body by plastic injection molding, and standard mounting and physical encapsulation/protection of the solar array, antenna, supercapacitor, microcontroller, and other electronics.

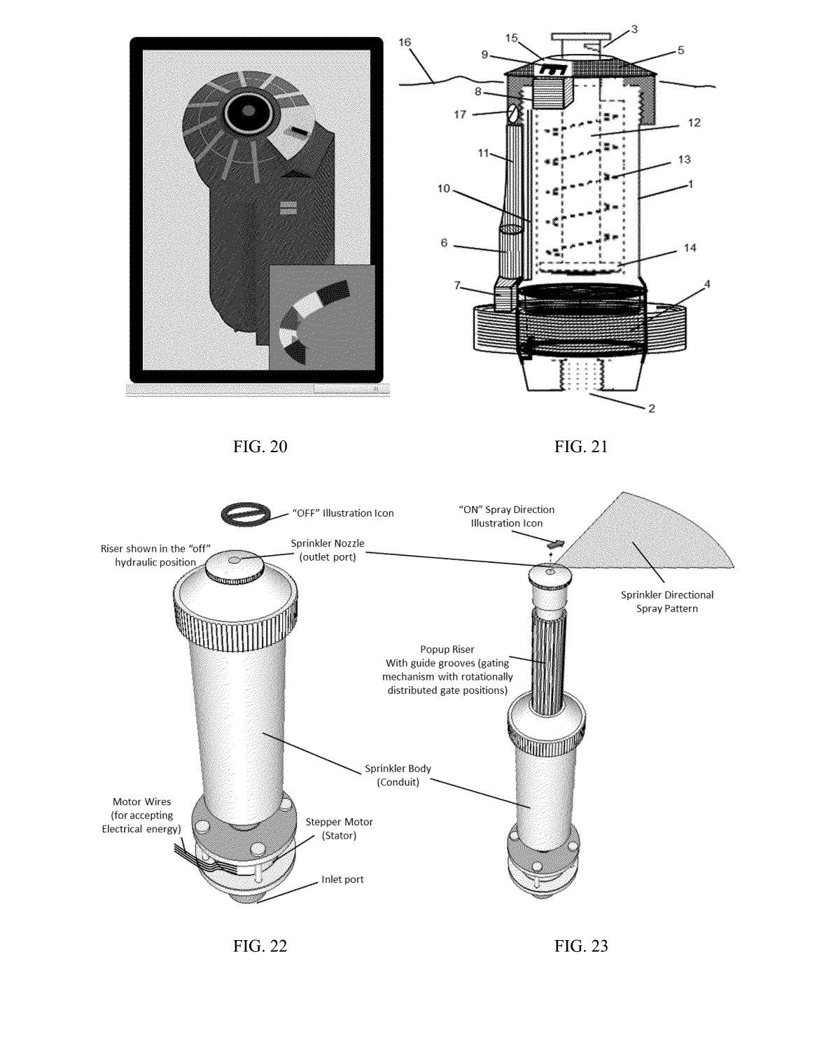

FIG. 20 shows a rendering of a modulation assisted valve (MAV) consistent with those disclosed in co-owned International Patent Application Number: PCT/US14/15641, Process and System for Controlling Modulation Assisted Valves for the Internet of Things. In some implementations of the current subject matter, electronics and electrical structure can be similar to those described for MAV implementations disclosed above. The following adds some details with respect to hydro-mechanical and electro-mechanical aspects of certain MAV implementations of the current subject matter.

FIGS. 20 and 21 show illustrations that appear, in many ways, as a common popup lawn sprinkler. However this is particularly a modulation assisted valve (MAV, as defined in the cited PCT application) that is controlled by the time-coordinated modulation of fluid (admitting or removing fluid pressure) at the valve's inlet and by electrical means local to the valve embodiment. Further discussion of FIG. 65 (which is slightly different that the present embodiment, but illustrated here for comparison) is discussed as a MAV embodiment in this document under the “invention” title Energy Harvesting Computerized Wireless Valve and is also disclosed by the present inventor in International Patent Application Number: PCT/US14/15641, Process and System for Controlling Modulation Assisted Valves for the Internet of Things.

The MAV implementations illustrated in FIG. 20 to FIG. 27 may exhibit additional advantages. In particular some advantages are indicated by the multi-colored arc icon in the lower right of FIG. 20 which is a mnemonic that indicates that this embodiment enables both the turning on and off by fluid modulation assisted radio control as well as being able to be controlled in its azimuthal spray direction (such as north, south, east, west, or similar fine angle compass directions).

FIG. 20 to FIG. 23 show an overview of some features. Firstly, the device may be likened to a standard popup lawn sprinkler having a riser that may be elevated upon admittance of pressure at the device's inlet port. Though only FIG. 20 and FIG. 21 show electronics on this embodiment, it is understood that these or similar electronics, in some form and mounting, will be used with the later figures of FIG. 22 through FIG. 28. The design and parts choice for the exact implementation and geometric and material attachment of such electronics is considered to be an exercise of choice that is easily performed by persons of ordinary skill in the art of electronics design and/or packaging. Such subject is further taught above, in the present document, and in the referenced PCT patent application filed by the present inventor. The radio and electronic control of such a device is known to comprise means of powering the device (such as a solar arrays or an encased small hydro-electric turbines), a means of storing electrical energy such as a capacitors or electro-chemical batteries, an on-board computer or microcontroller, and a radio frequency transceiver with which the device can send status (such as low battery/capacitor) or can receive commands or a schedule to turn on the device, and, in this embodiment, what direction the spray will be emitted when such an “on” event is executed.

As the power, communications, computation and control of the device is taught elsewhere in this document and in the mentioned PCT patent application, the ensuing teaching will concentrate primarily on the electro-mechanical and hydro-mechanical aspects of the present embodiment.

The materials and construction processes for this and other implementations of the current subject matter can be typical of those used in the plumbing and irrigation arts electronic devices. Various plastic parts (such as PVC, ABS, delrin, and others) can be used with, for the most part, typical injection molding processes. The electronics have also been discussed elsewhere in this and referenced documents, and are expected to be of typical electronic components, with the additional process of potting (encasing) in plastic or other means of hermetically sealing the device to guard against corrosion and problematic wetting, where that is an issue. Particularly, (and as discussed above and in cited references), a permanent magnet stepper motor with corrosive resistant ceramic magnet rotor, would be thought advantageous to use in this application due to its mechanical detent (or “cogging”) stability that tends to magnetically hold the motor in a set rotational position when power is removed. Other motors would could also be advantageous (and cheaper) if, for instance, frictional forces also hold the motor to its intended setting after removal of power.

FIG. 22 and FIG. 23 show the device to have a sprinkler body conduit (typically of plastic) a grooved popup riser interior to and moving axially within the sprinkler body, a sprinkler nozzle at the top of the riser, and a motor connected axially at the bottom inlet to the body conduit, and motor drive wires (or lead wires) connected so as to power and control the motor. Fluid flows into the inlet at the bottom and on one side of the motor, then moves axially through the motor stator (past an internal rotor (or magnetic “gate teeth”)), exits the other side of the motor stator and into the main body conduit of the sprinkler. If the motor has set the sprinkler as such, the fluid pressure pushes on the riser to raise it, pointing in a particular rotational direction, to spray irrigation out of its outlet. Depending on the initial rotational position (or gate position) of the riser when fluid is admitted at the device inlet, the riser may rise and spray fluid or it may be intentionally held firm, stopping the flow of fluid, such as when a target area is determined to have more than sufficient fluid sprayed on it. The illustration icons, “OFF” and “ON/direction” in the figures indicate these general states.

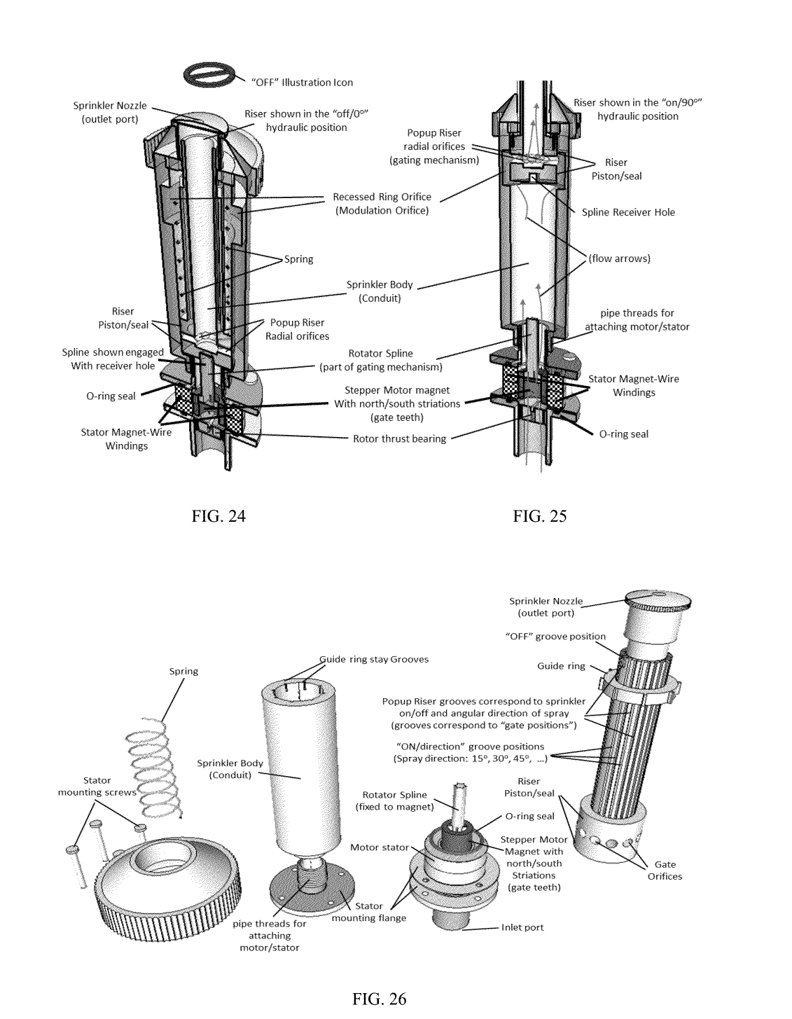

FIGS. 24 and 25 show a valve/sprinkler implementation in section view in both the “OFF” and “ON” states. There, we see a sprinkler nozzle attached at the top of the riser. Interior to the body we also see a “ring” orifice that is recessed into the wall of the valve body near its top. The base of the riser has a larger diameter than its top, where the larger diameter forms a riser “piston” or “seal” within the valve body. The piston is closed at the bottom and has radial fenestrations or orifices in its outer wall through which fluid can flow to the interior of the riser and out of the outlet port (nozzle). The piston is shaped such that, upon reaching a predetermined height within the conduit body, it encounters the recessed ring orifice, whereby fluid may travel through the recessed ring orifice, around the piston, and through the riser radial orifices to exit the nozzle. When the riser and piston are lower than this predetermined position in the valve body, the piston and seal impede the flow of fluid through the device, thus defining its “off” state. The figure shows a riser spring whose form and function is much like any other popup sprinkler and tends to push the riser to the bottom of the body conduit if not opposed by fluid pressure.

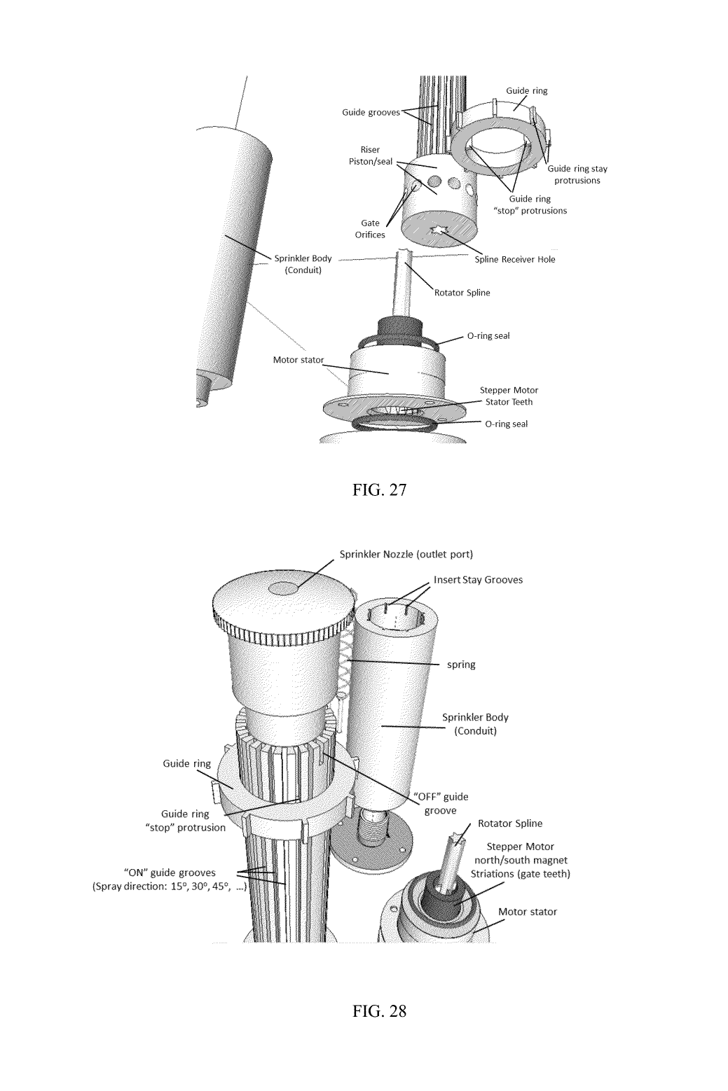

FIG. 24 and FIG. 25 further illustrate a spline receiver hole in the base of the riser. The shows that when the spring does so push the riser to the bottom of the body conduit, the riser engages at this receiver hole with a rotator spline that is attached to the hub of an axially mounted motor in the base of the valve. This rotator spline and receiver hole is also shown with greater detail in FIG. 27 and FIG. 28.

FIG. 24 and FIG. 25 further show how the interior axis of a permanent magnet stepper motor can comprise part of the base of the conduit, and can be connected, at its top and its bottom, with threads and stator mounting flanges (FIG. 26), to the valve body and inlet port.

The flanges are clamped to the motor stator using O-ring seals to contain fluid in the main valve conduit (now partially formed by the motor stator). The motor stator materials typically include a galvanized magnetic steel stator housing and copper wire windings (magnet wire). A sealing the interior of the motor stator with an epoxy, plastic, or other material, particularly where it contacts the working fluid, may prove advantageous so as to minimize corrosion of the motor stator. In actuality, the motor stator might contain zero iron or steal, but using such materials makes electric motors typically more efficient. Further, the could, in fact, be replaced with an electromagnetic configuration of coil wires, ferromagnetic materials, and/or permanent magnets that actuate an embodiment similar to this but only over a small angular travel, this travel being just enough to “unlatch” a rotating latch, allowing the popup riser (or similar gating structure), to preferentially be set to the “on” (flowing) or “off” (zero valve flow) state by actuation of such a simple latching mechanism. The present embodiment, instead, goes beyond that simple device to add greater angular control of the emitted spray angle. For example, a simple magnet and coil, or bi-stable solenoid, for example, that travels only a small distance, but then enables the spiraling up of a gating mechanism and stoppage of an orifice may be used instead of a stepper motor.

FIG. 24 and FIG. 25 show how the magnetic striations (alternating north and south poles) of the motor rotor form so called magnetic teeth to transfer force from the magnetic field created by the stator into the rotor, thus turning the rotor (a concept well known by persons of ordinary skill with electric motors). These gate teeth can be advantageously matched by motor stator teeth (see FIG. 27).

FIG. 26 to FIG. 28 further show a discrete number of indented guide grooves (or gate positions) that are located around the circumference and run the length of the popup riser. The exception to the long grooves is one groove (or subset of grooves) that run only a short distance down the riser. This exceptional groove is labeled in FIG. 26 and called the “OFF” guide groove position. Each of the longer guide grooves is associated with a commanded spray direction of the sprinkler at settings of 15, 30, 45, 60 . . . etc. degrees. (Under operation, these spray positions are associated with what are called hydraulic positions).

A guide ring that has both “stop” protrusions on its interior circumference, and “stay” protrusions on its exterior circumference is shown in FIG. 27. The guide ring is fixed in the valve body by the body cap and kept from rotating by the guide ring stay grooves (FIG. 26). The grooved riser is fitted into the guide ring where the riser guide grooves mesh with one (or more) of the guide ring “stop” protrusions. When the “OFF” riser guide groove is meshed with the guide ring stop, the riser is held from rising out of the valve body. ring where the riser guide grooves mesh with one (or more) of the guide ring “stop” protrusions. When any of the other riser guide grooves (15, 30, 45 degree grooves) is meshed with the guide ring stop, the riser is allowed to rise out of the valve body at the rotational angle associated with that guide groove (see FIG. 28).

In an alternate implementation, the riser can have only, for example, two grooves: and “on” (long) and an “off” (short) groove. This alternate groove arrangement can allow the sprinkler to turn on and off without varying the spray directional angle. This alternate (two, or only a few, grooves) could simplify the electromechanical means (electric motor) to a more simple structure (say, like a two-position latching solenoid) simply for the “on” and “off” positions, making the device less capable but also less costly to manufacture.

We may define an initial state of the direction controlled MAV as that of being attached to a pipe network (typically a plant irrigation system). An external means (such as an irrigation branch solenoid valve) is controlled to remove pressure or flow from the inlet port of this embodiment of the MAV. The MAV, as discussed, can be provisioned with and utilize power from a connected hydro-electric turbine or solar array, and also have all of the energy storage, on-board computer, and radio communications equipment, as previously discussed. Also as elsewhere disclosed, this embodiment of MAV can similarly receive commands over radio frequency from a similarly equipped radio controller.

The riser sits in the bottom of the valve body with the rotator spline inserted and engaged in the riser spline receiver hole. The rotational state of the motor rotor is at the zero angle position, which is defined as the rotational position where the riser “OFF” guide groove rotationally aligns with the guide ring stop protrusions, near the top of the valve body. The rotor magnetic cogging force and spline insertion hold the rotor at this rotational angle. However, the guide ring stop protrusions protrude into the valve body just above the start of the guide groove such that the protrusion and guide groove are not quite yet engaged. At this position, if the motor rotor were rotated the riser could rotate freely with it.

At this initial “OFF” position, if the irrigation branch solenoid valve (this example's external means of modulating pressure) were turned on (modulated), pressure would be applied at the inlet port and to the bottom of the riser piston, pushing it upward. However, due to the “OFF” rotational angle of the riser, after a short vertical distance travel of the riser, the “OFF” riser guide groove would engage with the guide ring stop protrusions, limiting its vertical travel to a very short distance. The riser piston/seals would restrict fluid from moving through the valve body or through the riser center, thus rendering the valve (or sprinkler) “OFF.” The solenoid could then again cut pressure to the valve, allowing it to settle to the bottom again, onto the rotator spline, and with guide ring stop protrusions just beyond the ends of all riser guide grooves. This, again, could be called its initial or zero position.

Then, with zero pressure being applied to the inlet of the valve/sprinkler, the discussed on-board computer could be commanded by radio (or by a locally hosted electronic clock and previously radio-programmed schedule) to rotate the motor rotor to a particular step angle, the angle corresponding to a sprinkler spray direction (e.g. 15, 30, . . . etc. degrees). The motor, engaged by the splines, would freely turn the riser (by computer command and actuation under the power of locally stored electric power) to the prescribed angular position. At that angular position, the particular corresponding riser guide groove would align just below (but very near) the guide ring stop protrusion. Then, the external means of re-admitting pressure (modulating pressure) would then be commanded by a controller to re-admit pressure back into the valve inlet (or back into the irrigation branch). At this point, fluid pressure would move through the valve motor center (part of the conduit) and impinge upon the base of the riser piston. The riser would react by moving upward under such force, and now engage one of the “ON” riser guide grooves (15, 30, . . . etc. degrees) with the guide ring stop protrusions (see state illustrated at top of FIG. 28). As these “ON” guide grooves are longer (run the length of the riser), the riser would slide up (as is common for a popup sprinkler) until the guide ring stop protrusions reached the end of the particular guide grooves, thus extending the riser up, fully. At this high riser position, the riser piston and radial orifice holes would be arranged in such a way so as to allow fluid to move around the base of the piston, into the body conduit recessed ring orifice, through the riser radial orifices, up the riser, and out of the sprinkler nozzle (see the flow arrows in FIG. 25). Fluid pressure at the inlet port would hold the riser in this position, spraying at the predetermined angle until pressure was removed from the inlet port.

When pressure was removed by command of the external solenoid (or other) valve, the riser would fall back to its rest position where the on-board computer or microcontroller could then command it (or not) to rotate back to its “zero” or “OFF” position.

The current subject matter can include various advantages, such as for example alternative and advantageous means of constructing and operating remote, energy autonomous and energy harvesting (typically solar or micro-hydro-turbine powered), wirelessly-communicating and controlled, valves that use only electrical capacitors for energy storage without the need for (but not excluding) chemical batteries.

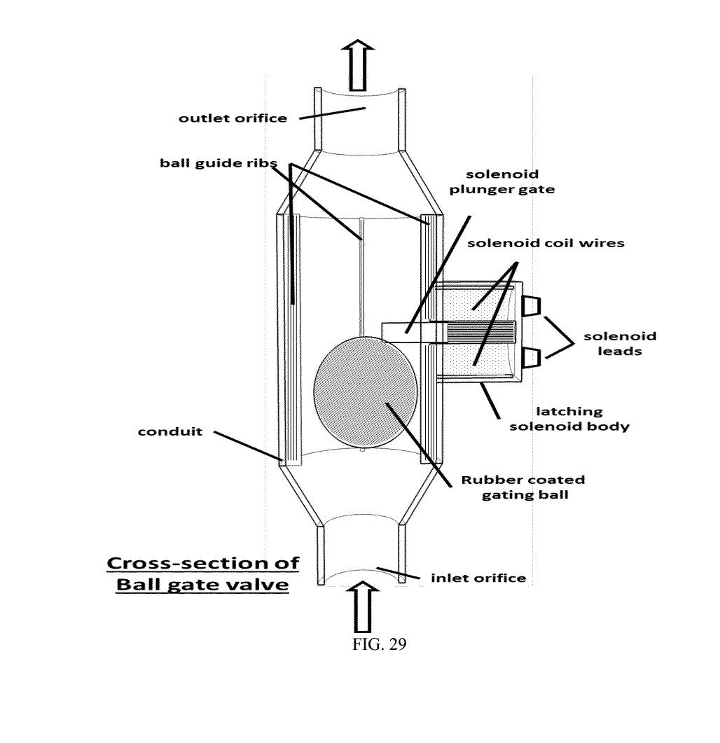

In some implementations of the current subject matter, a modulation assisted valve (MAV) can be referred to as a ball gate valve, such as that shown in FIG. 29. This example of a ball gate valve can be connected with and controlled by, and in coordination with, solar powered modules and radio communications, and can optionally be exclusively powered by the capacitive electrical energy storage devices as further discussed in this document.

The valve of FIG. 29 may be operated in a vertical orientation (as shown) under earth's gravity, by first, removing the application of fluid (modulating) flow at the inlet of the valve while the latching solenoid plunger gate is retracted (plunger state opposite of how shown in the figure, and allowing movement of the ball within the conduit). In this implementation, the ball is of a mean material density that is slightly greater (heavier) than the working fluid such that gravity pulls the ball to rest at the bottom of the conduit and below the latching solenoid plunger gate. This would also be the case if the ball were of density less than (lighter than) the working fluid and where the fluid was totally drained from the valve, the ball would float downward and similarly come to rest at the bottom of the conduit.).

After removing fluid flow from (or draining) the inlet, the latching solenoid plunger can then be latched to the extended (blocking) position (by passing an appropriate magnitude and polarity current pulse through the solenoid winding wires), thus confining the ball to the bottom of the conduit and toward the center of same by the ball guide ribs. The ribs and ball are situated such that re-admitting fluid flow back into the inlet port of the valve will allow fluid to flow around the ball (the plunger retaining the ball), flow along the ball guide ribs, and allowed to flow out of the outlet port of the valve, thus operating the valve in its “open” state.

Conversely, if the latching solenoid plunger gate were not, in fact, actuated to the extended position, as above, the ball would not be retained and, when a predetermined velocity of fluid was re-admitted back into the inlet port, the ball would float or be moved to the top of the conduit and into the conically shaped region of the outlet port, thus blocking fluid from exiting the valve and effectively maintaining the valve in the “off′ (blockage of flow) state. Indeed, the surface of the said conically shaped region of the outlet port can be constructed of, or covered by” a sealant material (such as rubber) so as to make a good pressure seal with the ball.

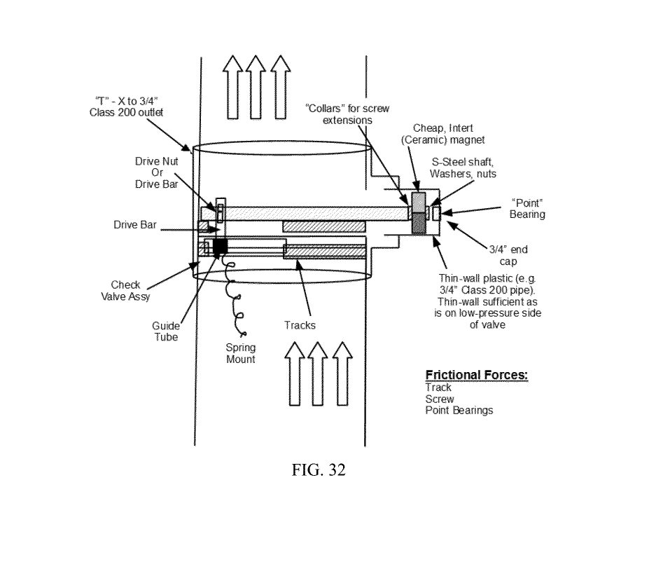

FIG. 32 shows a sliding trap door modulation assisted valve that is an example of a modulation assisted valve that can be actuated an electromagnetic motor encased in the fluid and that turns a lead screw to move a trap-door like gate, with little friction, under the assumption that no little or no fluid flow or pressure is allowed to enter the inlet of the valve.

The preceding paragraphs teaching on the structure of the solar powered, radio enabled, capacitive energy storing, sliding trap door valve, ball gate valve and its process of operation by modulation of fluid across the valve by external means, serves to further support these valve as another species of the genus “modulation assisted valve” (MAV). This is given further support by the construction and operation of the popup sprinkler integrated with a modulation assisted valve (MAV) in FIG. 31, whose construction and operation are taught in provisional patent application Ser. No. 61/762,703 and follow-on PCT (which are included in this document by reference).

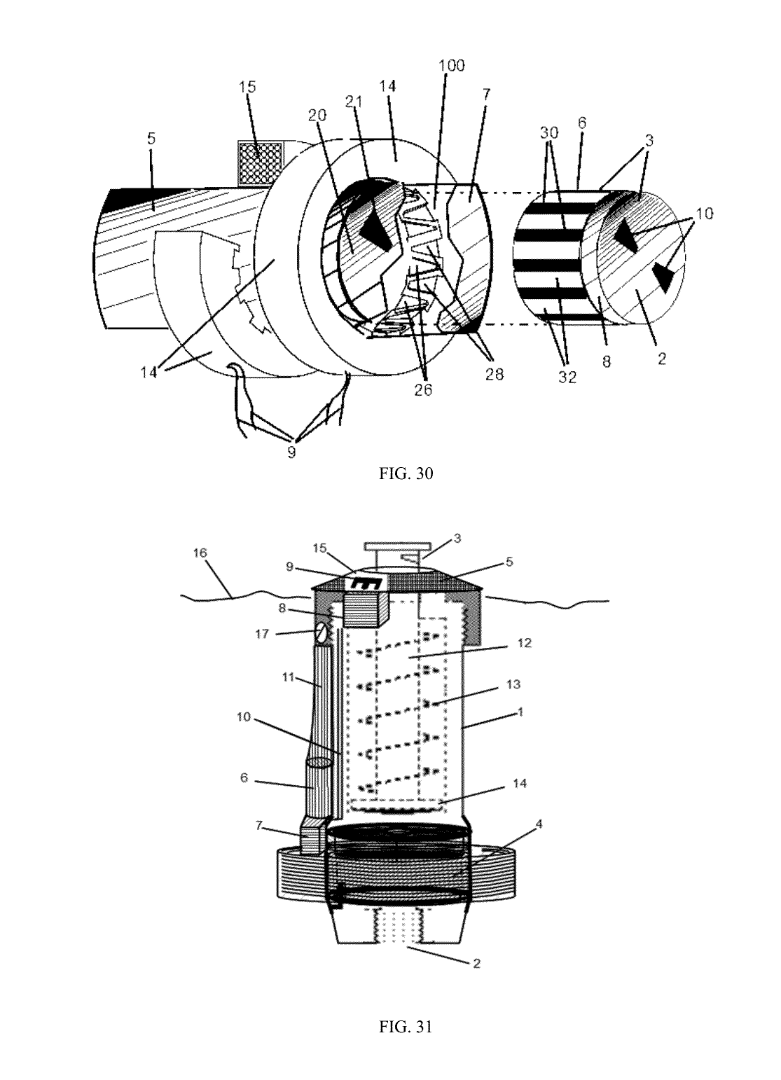

The valves, FIG. 29 and FIGS. 30/31 and FIG. 32 represent examples of a “modulation assisted valve” (MAV). Among other possible implementations of the current subject matter, the examples shown in and explained in reference to FIG. 29 and FIGS. 30/31 and FIG. 32 include “modulation assisted valves” that, if necessary, may be powered by energy harvesting from the ambient environment (e.g. solar power), may be radio communications enabled, and/or may be capable of storing energy by electrical capacitance and/or a chemical battery), a and may be used in plant irrigation fluid delivery.

It is further stated that, wherever the term “super capacitor” is used, herein, that term can equivalently be interpreted or read as “lithium-ion capacitor.”

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A valve comprising:
a conduit comprising an inlet and an outlet, the conduit configured to receive a fluid via the inlet and discharge the fluid from the outlet after the fluid passes through the conduit;
a motor comprising a stator and a magnetic rotor, the magnetic rotor disposed to contact the fluid as the fluid passes through the conduit and being positioned with a rotor axis of rotation substantially aligned with a direction of fluid flow through the conduit, the stator disposed to at least partially encircle the magnetic rotor and to cause rotation of the magnetic rotor around the rotor axis of rotation in response to electrical power provided to the motor; and
a modulating orifice located between the inlet and outlet, the modulating orifice comprising a flow passage through which fluid can flow;
a flow control element connected to the magnetic rotor such that the flow control element moves in response to rotation of the magnetic rotor, movement of the flow control element causing a size of the flow passage of the modulating orifice to change in a controllable manner.

2. The valve of claim 1, wherein movement of the flow control element is reciprocal in a direction along the rotor axis of rotation.

3. The valve of claim 2, wherein the flow control element comprises a tapering shape with a first cross sectional size that is smaller than a second cross sectional size, the first cross sectional size of the flow control element being disposed closer to the modulating orifice than the second cross sectional size of the flow control element.

4. The valve of claim 1, wherein the flow control element rotates about an axis that is parallel to the rotor axis of rotation to change the size of the modulating orifice.

5. The valve of claim 4, wherein the flow control element and the modulating orifice each include one or more orifices, and wherein rotation of the flow control element causes these one or more elements to move into greater or lesser alignment to change the size of the flow passage.

6. The valve of claim 1, wherein the motor allows flow of the fluid through the motor as the fluid passes through the conduit.

7. The valve of claim 1, wherein the stator has an at least partially toroidal shape, and the at least partially toroidal shape, the magnetic rotor, and a cylindrical shape of the conduit are aligned concentrically.

8. The valve of claim 1, wherein at least an inner surface of the at least partially toroidal shape of the stator is disposed in contact with the fluid.

9. The valve of claim 8, wherein the stator is formed of and/or comprises a coating of a corrosion-resistant material.

10. The valve of claim 1, wherein the magnetic rotor is formed of and/or comprises a coating of a corrosion-resistant material.

11. A method comprising:
receiving a fluid into an inlet of a conduit of a valve;
causing rotation of a magnetic rotor about a rotor axis of rotation in response to electrical power provided to a motor comprising the magnetic rotor and a stator; the magnetic rotor disposed to contact the fluid as the fluid passes through the conduit and positioned with a rotor axis of rotation substantially aligned with a direction of fluid flow through the conduit, the stator disposed to at least partially encircle the magnetic rotor; and
moving a flow control element connected to the magnetic rotor in response to the rotation of the magnetic rotor, movement of the flow control element causing a size of a flow passage of a modulating orifice to change in a controllable manner, the modulating orifice disposed between the inlet and an outlet of the conduit.

12. The method of claim 11, wherein movement of the flow control element is reciprocal in a direction along the rotor axis of rotation.

13. The method of claim 12, wherein the flow control element comprises a tapering shape with a first cross sectional size that is smaller than a second cross sectional size, the first cross sectional size of the flow control element being disposed closer to the modulating orifice than the second cross sectional size of the flow control element.

14. The valve of claim 1, wherein the flow control element rotates about an axis that is parallel to the rotor axis of rotation to change the size of the modulating orifice.

15. The method of claim 14, wherein the flow control element and the modulating orifice each include one or more orifices, and wherein rotation of the flow control element causes these one or more elements to move into greater or lesser alignment to change the size of the flow passage.

16. The method of claim 11, wherein the motor allows flow of the fluid through the motor as the fluid passes through the conduit.

17. The method of claim 11, wherein the stator has an at least partially toroidal shape, and the at least partially toroidal shape, the magnetic rotor, and a cylindrical shape of the conduit are aligned concentrically.

18. The method of claim 11, wherein at least an inner surface of the at least partially toroidal shape of the stator is disposed in contact with the fluid.

19. The method of claim 18, wherein the stator is formed of and/or comprises a coating of a corrosion-resistant material.

20. The method of claim 11, wherein the magnetic rotor is formed of and/or comprises a coating of a corrosion-resistant material.
